(19) United States
(12) Patent Application Publication
(10) Pub. No.: US 2020/0016602 A1
(43) Pub. Date: Jan. 16, 2020

(54) ROTARY REDUCING COMPONENT

(71) Applicant: Vermeer Manufacturing Company, Pella, IA (US)

(72) Inventors: Clint Weinberg, Pella, IA (US); Stephen Daining, Pella, IA (US)

(21) Appl. No.: 16/507,513

(22) Filed: Jul. 10, 2019

Related U.S. Application Data
(60) Provisional application No. 62/697,139, filed on Jul. 12, 2018.

(51) Int. Cl. B02C 18/18

(52) U.S. Cl. CPC B02C 18/18; A01G 23/067

(57) ABSTRACT

A reducing element system includes a reducing element having a main body defining a fastener opening, a leading face defined by the main body, and a trailing face defined by the main body. The trailing face includes a pair of mating features equally spaced from the fastener opening and having a generally arcuate cross-section perpendicular to a fastener axis. The system further includes a reducing element mount having a main body defining a fastener opening, a leading face defined by the main body, and a reducing element mount mating feature defined by the leading face. The mount mating feature has a generally arcuate cross-section perpendicular to the fastener axis. The reducing element mount mating feature of the reducing element mount is configured to mate with at least one of the mating features of the reducing element when the reducing element mount is mated with the reducing element.

### RELATED APPLICATIONS

This application claims the benefit of U.S. Provisional Patent Application No. 62/697,139 filed on Jul. 12, 2018, the entire content of which is hereby incorporated by reference herein.

### BACKGROUND

Material reducing machines are machines used to reduce the size of material by processes such as mulching, chipping, grinding, cutting, or like actions. A typical material reducing machine includes a rotary reducing component that reduces material as the material reducing component rotates about a central axis. In certain examples, the rotary reducing component works in combination with other structures such as screens or anvils to facilitate the material reduction process. In certain examples, the rotary reducing component includes a main rotating body (e.g., a rotor, drum, plate stack, or like structures) and a plurality of reducing elements (e.g., knives, cutters, reducing elements, blades, hammers, teeth, or like structures) carried by the main rotating body. In certain examples, the reducing elements are positioned about a circumference of the main rotating body and are configured to define a circular cutting boundary as the rotary reducing component is rotated about its central axis.

A forestry mower is an example of one type of material reducing machine. A forestry mower typically includes a vehicle such as a tractor or skid-steer vehicle. A material reducing head is coupled to the vehicle (e.g., by a pivot arm or boom). The material reducing head includes a rotary reducing component, which often incorporates a rotating drum that carries a plurality of reducing elements (e.g., blades, teeth, etc.). The material reducing head can be raised and lowered relative to the vehicle, and can also be pivoted/tilted forward and backward relative to the vehicle. By raising the reducing head and tilting the reducing head back, the forestry mower can be used to strip branches from trees and other aerial applications. By lowering the reducing head and pivoting the reducing head forward, the forestry mower can readily be used to clear brush, branches, and other material along the ground.

The design of reducing elements varies drastically for a wide range of applications. However, the design of reducing elements can drastically affect the operation of the material reducing machine. For example, the arrangement of a cutting element can reduce both the effectiveness and efficiency of a material reducing machine.

Therefore, improvements in reducing element design are needed.

### SUMMARY

The present disclosure relates generally to a material reducing apparatus. In one possible configuration, and by non-limiting example, a tooth having an increased chipping productivity is disclosed.

In one example of the present disclosure, a reducing element system is disclosed. The reducing element system includes a reducing element having a main body defining a fastener opening for securing the reducing element to a reducing element mount, a leading face defined by the main body and having a first cutting edge, and an opposite second cutting edge. The first and second cutting edges are equally spaced from the fastener opening. A trailing face is defined by the main body, the trailing face being opposite of the leading face. The trailing face includes a mounting face that is configured to mount to the reducing element mount, and a pair of mating features defined by the trailing face, the mating features being equally spaced from the fastener opening. The mating features have a generally arcuate cross-section perpendicular to a fastener axis. The system further includes a reducing element mount having a main body defining a fastener opening for securing the reducing element to the reducing element mount and a leading face defined by the main body. The leading face includes a reducing element mounting face configured to receive the mounting face of the reducing element, and a reducing element mount mating feature defined by the leading face. The mating feature has a generally arcuate cross-section perpendicular to the fastener axis. The reducing element mount mating feature of the reducing element mount is configured to mate with at least one of the mating features of the reducing element when the reducing element mounting face is mated with the mounting face of the reducing element.

A variety of additional aspects will be set forth in the description that follows. The aspects can relate to individual features and to combinations of features. It is to be understood that both the foregoing general description and the following detailed description are exemplary and explanatory only and are not restrictive of the broad inventive concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates a perspective view of a material reducing apparatus according to one embodiment of the present disclosure.

FIG. 2 illustrates a side view of the material reducing apparatus of FIG. 1.

FIG. 3 illustrates a schematic longitudinal cross section of the material reducing apparatus of FIG. 1.

FIG. 4 illustrates a perspective view of a rotary reducing component, according to one embodiment of the present disclosure.

FIG. 5 illustrates a front view of the rotary reducing component of FIG. 4.

FIG. 6 illustrates a side view of the rotary reducing component of FIG. 4.

FIG. 7 illustrates a schematic side view of the rotary reducing component of FIG. 4.

FIG. 8 illustrates a perspective view of a reducing element and a reducing element mount, according to one embodiment of the present disclosure.

FIG. 9 illustrates an exploded view of the reducing element and the reducing element mount of FIG. 8.

FIG. 10 illustrates a front view of the reducing element and the reducing element mount of FIG. 8.

FIG. 11 illustrates a cross-sectional view of the reducing element and the reducing element mount along line 11-11 in FIG. 10.

FIG. 12 illustrates a front perspective view of the reducing element of FIG. 8.

FIG. 13 illustrates a rear perspective view of the reducing element of FIG. 8.

FIG. 14 illustrates a front view of the reducing element of FIG. 8.

FIG. 15 illustrates a cross-sectional view of the reducing element along line 15-15 in FIG. 14.

FIG. 16 illustrates a rear view of the reducing element of FIG. 8.

FIG. 17 illustrates a side view of the reducing element of FIG. 8.

FIG. 18 illustrates a front perspective view of a reducing element, according to one embodiment of the present disclosure.

FIG. 19 illustrates a side view of the reducing element of FIG. 18.

FIG. 20 illustrates a front perspective view of a reducing element, according to one embodiment of the present disclosure.

FIG. 21 illustrates a side view of the reducing element of FIG. 20.

FIG. 22 illustrates a schematic side view of the reducing element of FIG. 8 mounted to the rotary reducing element of FIG. 4.

FIG. 23 illustrates a schematic side view of the reducing element of FIG. 18 mounted to the rotary reducing element of FIG. 4.

FIG. 24 illustrates a schematic side view of the reducing element of FIG. 20 mounted to the rotary reducing element of FIG. 4.

FIG. 25 illustrates a side view of a reducing element mount, according to one embodiment of the present disclosure.

FIG. 26 illustrates a front perspective view of the reducing element mount of FIG. 25.

FIG. 27 illustrates a rear perspective view of the reducing element mount of FIG. 25.

FIG. 28 illustrates a front perspective view of an exploded assembly that includes a reducing element and a reducing element mount, according to one embodiment of the present disclosure.

FIG. 29 illustrates a rear perspective view of the exploded assembly of FIG. 28.

FIG. 30 illustrates a rear view of the reducing element of the assembly of FIG. 28.

FIG. 31 illustrates a side view of the reducing element mount of the assembly of FIG. 28.

FIG. 32 illustrates a front view of the reducing element mount of the assembly of FIG. 28.

FIG. 33 illustrates a side view of the assembly of FIG. 28.

FIG. 34a illustrates a cross-sectional view of the assembly of FIG. 28 along line 34-34.

FIG. 34b illustrates a cross-sectional view of a reducing element and a reducing element mount, according to one embodiment of the present disclosure.

FIG. 34c illustrates a cross-sectional view of a reducing element and a reducing element mount, according to one embodiment view of the present disclosure.

FIG. 34d illustrates a cross-sectional view of a reducing element and a reducing element mount, according to one embodiment of the present disclosure.

FIG. 35 illustrates a perspective view of a rotary reducing component, according to one embodiment of the present disclosure.

FIG. 36 illustrates a top schematic view of a portion of the rotary reducing component of FIG. 35.

FIG. 37 illustrates a front perspective view of a portion of the rotary reducing component of FIG. 35.

FIG. 38 illustrates a rear perspective view of a portion of the rotary reducing component of FIG. 35.

FIG. 39 illustrates another front perspective view of a portion of the rotary reducing component of FIG. 35.

FIG. 40 illustrates another rear perspective view of a portion of the rotary reducing component of FIG. 35.

FIG. 41 illustrates another front perspective view of a portion of the rotary reducing component of FIG. 35.

FIG. 42 illustrates another rear perspective view of a portion of the rotary reducing component of FIG. 35.

FIG. 43 illustrates a schematic side view of a depth control device, according to one embodiment of the present disclosure.

FIG. 44 illustrates a schematic side view of a depth control device, according to one embodiment of the present disclosure.

FIG. 45 illustrates a schematic side view of a depth control device, according to one embodiment of the present disclosure.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The machine and associated rotary reducing component and reducing element design disclosed herein have several advantages. For example, the rotary reducing component and reducing element are configured to achieve a high productivity during a material reducing operation. Further, the rotary reducing component and reducing element disclosed herein are configured to be resilient to foreign material strikes and perform after being sharpened multiple times. Further still, the reducing elements are configured to be reversible, having a pair of cutting edges to increase the overall life of the reducing element.

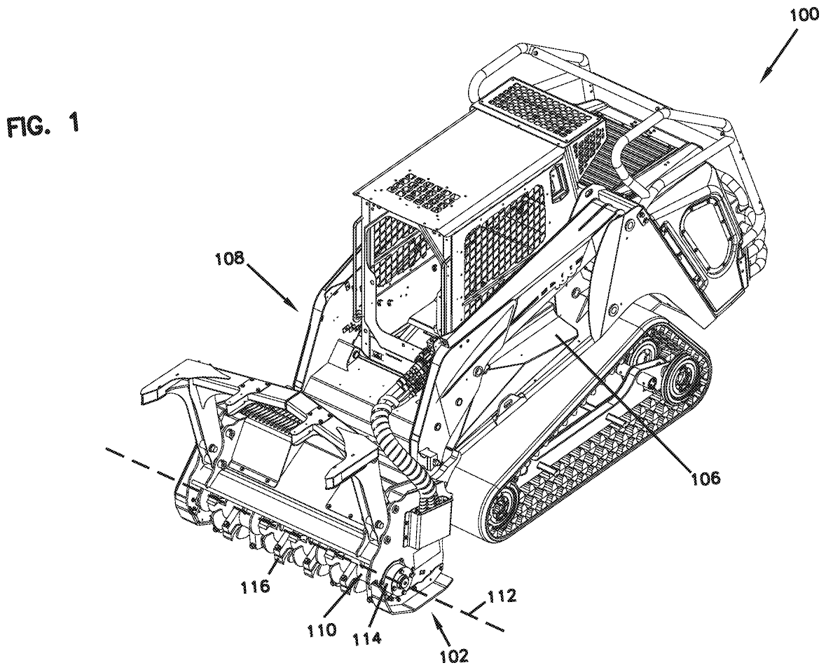

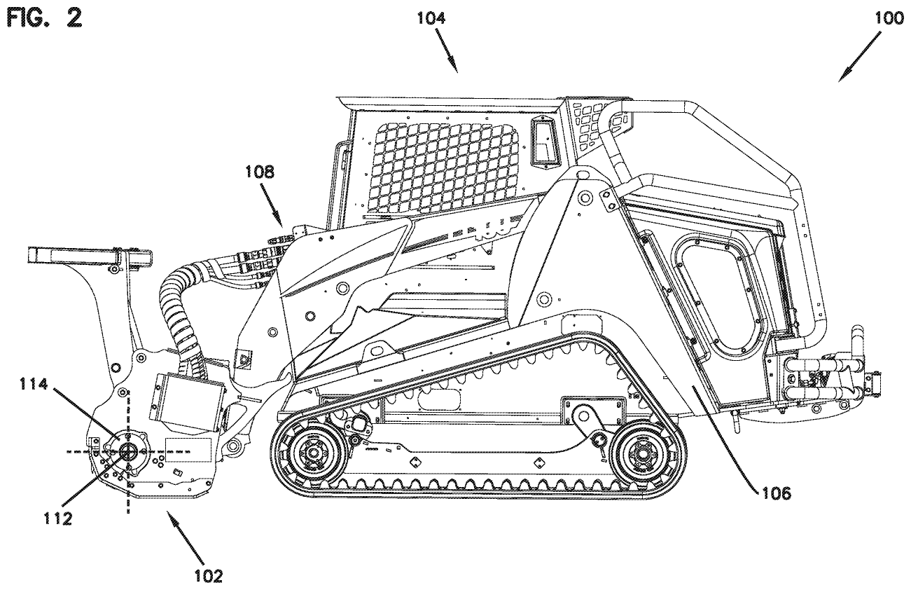

FIGS. 1-3 illustrate a material reducing apparatus in accordance with the principles of the present disclosure. As depicted, the material reducing apparatus is shown as a forestry machine 100 (also known, for example, as a forestry mower or forestry mulcher) including a material reducing head 102 carried by a vehicle 104. The vehicle 104 is depicted as a track loader, but could be any other type of vehicle, such as a wheeled or tracked tractor. The vehicle 104 includes a main frame 106. A linkage (e.g., a boom 108 including a boom arm, a pair of spaced-apart boom arms, or other structures) connects the material reducing head 102 to the frame 106 of the vehicle 104. The boom 108 can be pivoted up and down to raise and lower the material reducing head 102 relative to the frame 106. Further, the material reducing head 102 can pivot to tilt forwardly and rearwardly relative to the frame 106.

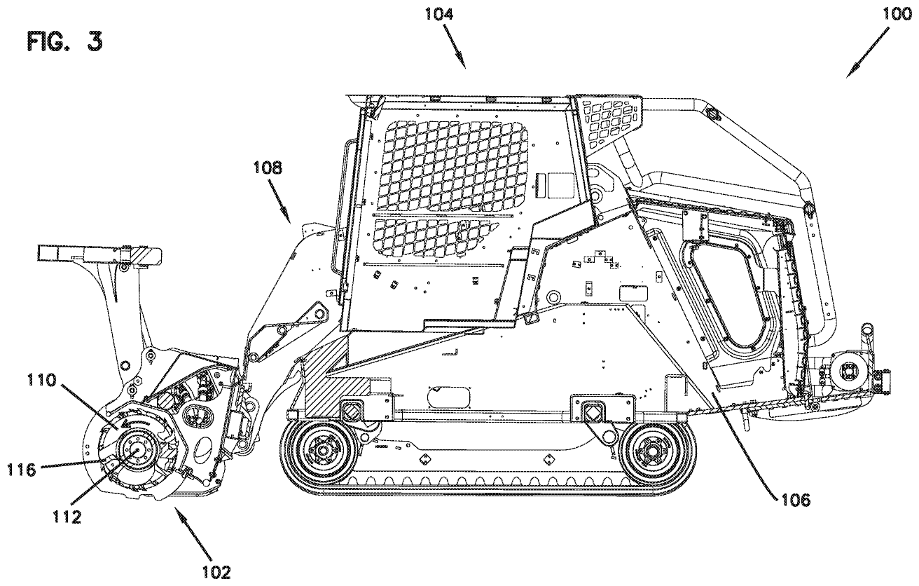

The material reducing head 102 includes a rotary reducing component 110 (e.g., a rotor/drum) that is rotated about a central axis 112. At least one motor 114 can be provided for rotating the rotary reducing component 110 about the central axis 112. The rotary reducing component 110 can include a drum, shaft, or other main body which carries a plurality of reducing elements 116. During normal operation, when viewing the cross-section of the rotary reducing component 110 from the left side of the forestry mower 100 (as shown in FIG. 3), the rotary reducing component 110 rotates in a counter clockwise direction.

While the reducing machine 100 is shown to be a forestry machine, it is contemplated to be within the scope of the present disclosure that the rotary reducing component 110 and reducing elements 116 can be utilized on a wide range of machines that utilize a rotary reducing component. For example, the rotary reducing component 110 and reducing elements 116 can be used in a grinder machine such as a horizontal grinder, tub grinder, brush chipper or the like. An example of a horizontal grinder can be found in U.S. Pat. No. 9,168,535; an example of a tub grinder can be found in U.S. Pat. No. 9,505,007; and an example of a brush chipper can be found in U.S. Pat. No. 9,409,310; all of which are hereby incorporated by reference in their entirety.

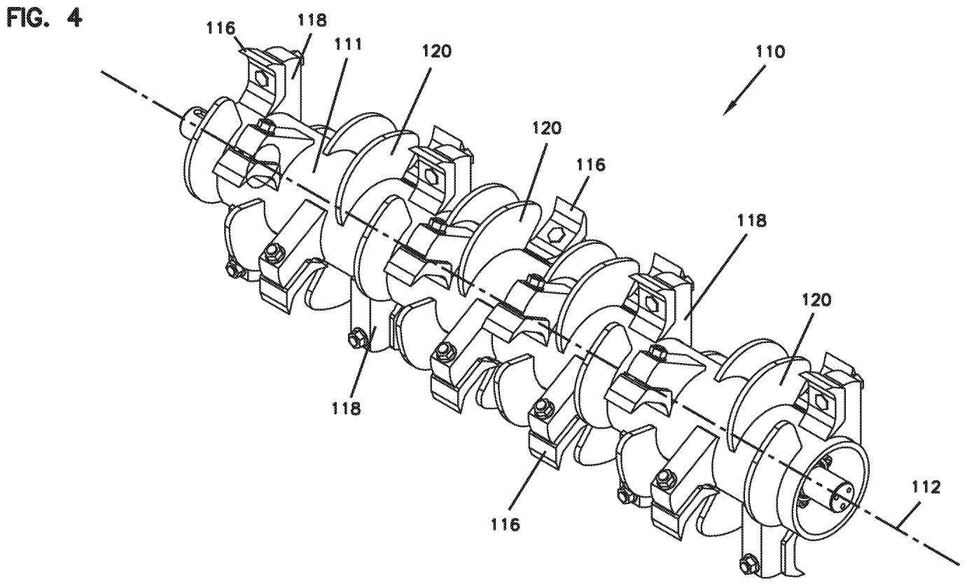

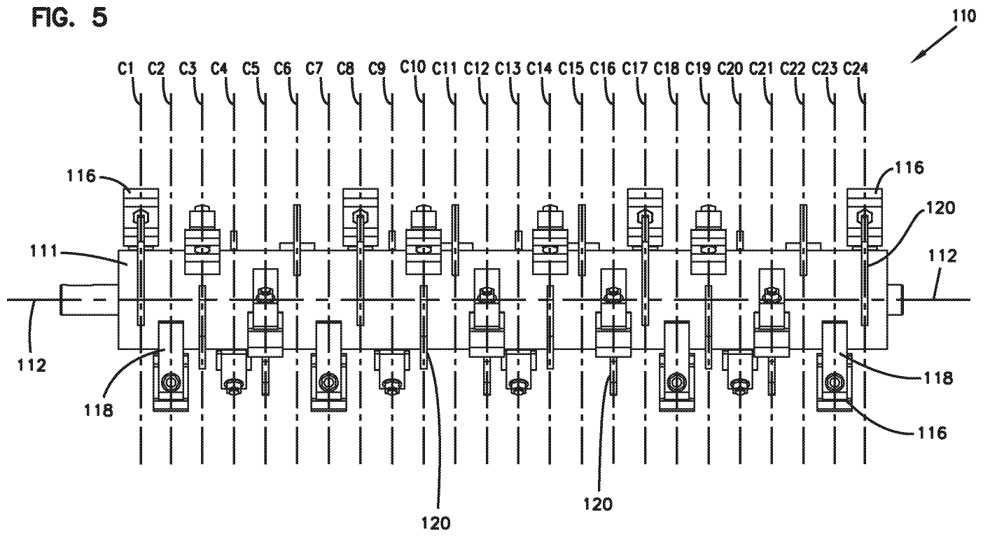

FIG. 4 shows a perspective view of the rotary reducing component 110. FIG. 5 shows a front view of the rotary reducing component 110. The rotary reducing component 110 includes the plurality of reducing elements 116 mounted to a plurality of reducing element mounts 118. The reducing element mounts 118 are mounted to a main body 111 (i.e., a hollow shaft, a drum, a plurality of discs, a plurality of bars, etc.). Further, the rotary reducing component 110 includes a plurality of depth control devices 120.

The rotary reducing component 110 has a plurality of cutting paths (labeled C1-C24) spaced along the central axis 112 of the rotary reducing component 110. Each of the cutting paths is defined by or coincides with a single one of the reducing elements 116. Thus, during reducing, each path makes only one impact per revolution of the rotary reducing component 110. The rotary reducing component 110 can have a range of different qualities of reducing elements 116 mounted thereto. Further, the rotary reducing component 110 can be a variety of different diameters and lengths depending on its application.

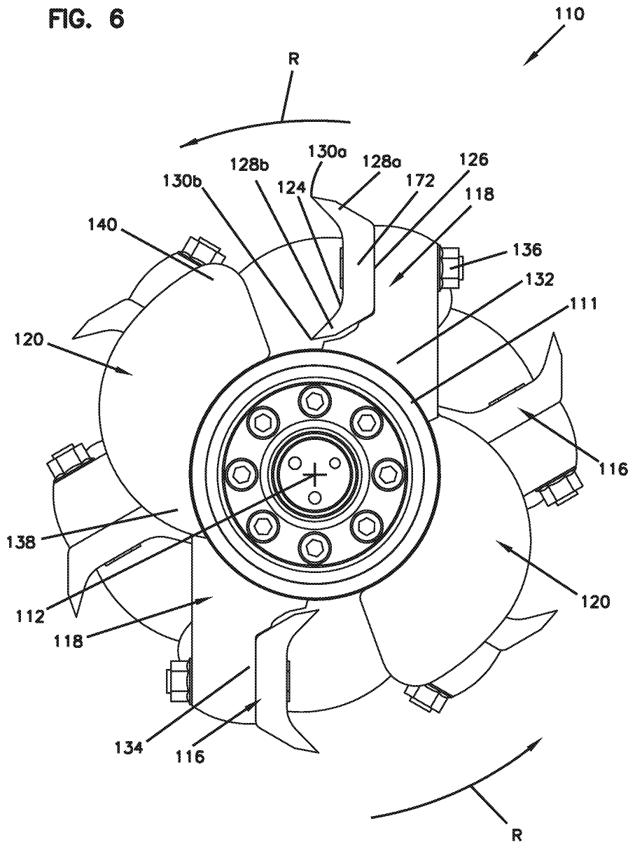

The reducing elements 116 are relatively sharp, block-like cutters suitable for chipping. As shown in FIG. 6 in the side view of the rotary reducing component 110, each of the reducing elements 116 includes a main body 122 and have a leading face 124 (e.g., a front side) and a trailing face 126 (e.g., a rear side). In some examples, the leading face 124 can be concave. In some examples, each reducing element 116 is at least partially ornamental in nature and features nonfunctional elements.

Further, each reducing element 116 is reversible in that each reducing element includes a pair of cutting heads 128a, 128b. The cutting heads 128a, 128b each include a cutting edge 130a, 130b that define a linear cutting plane. Further, the first and second cutting edge 130a, 130b also define at an interface between the leading face 124 and the trailing face 126. The edges 130a, 130b can be relatively sharp and can extend generally across an entire width of the main body 122 of the reducing element 116.

In operation, the reducing element 116 can be mounted in a first orientation where the cutting edge 130a is positioned to encounter material that will be reduced. Alternatively, the reducing element 116 can be mounted in a first orientation where the cutting edge 130b is positioned to encounter material that will be reduced. The cutting edge 130a/130b that is performing the reducing operation can be referred to as the live cutting edge. In operation, the user can alter which cutting edge 130a, 130b is the live cutting edge by rotating the reducing element 116 to a position wherein the intended live cutting edge is positioned further away from the main body 111 of the rotary reducing component 110 as compared to the opposite, corresponding cutting edge 130a, 130b. This allows the user to choose a cutting edge 130a, 130b based on the characteristic of the cutting edge (e.g., sharpness and/or general cutting edge condition). Further, it allows the user to continue using a reducing element 116 even if one cutting edge 130a, 130b becomes damaged. Finally, it gives the user two sharpened cutting edges 130a, 130b that allow the user to perform a reducing operation without having to stop to sharpen reducing elements 116.

When the reducing element 116 is secured to the reducing element mount 118, the trailing face 126 abuts against the reducing element mount 118, and the leading face 124 faces toward the direction of rotation (as shown by arrows R in FIG. 6).

Each reducing element mount 118 is coupled with the main body 111 of the rotary reducing component 110 at a base 132 and coupled with a reducing element 116 at a reducing element mount leading face 134 via a fastener 136. Each reducing element mount 118 extends radially away from the main body 111 so that the reducing element mount leading face 134 faces in the direction of the rotation R.

Each depth control device 120 is configured to limit the depth of cut of each corresponding reducing element 116. Further, each depth control device 120 aids in controlling depth of nearby or adjacent reducing elements in the case where the material to be cut is wider than a single reducing element. As shown in FIG. 5, a depth control device 120 is paired with each reducing element 116. Specifically, the depth control device 120 is mounted to the main body 111 of the rotary reducing component 110 adjacent each reducing element 116 and reducing element mount 118 so that, during rotation of the rotary reducing component 110, the depth control device 120 passes by a point prior to the reducing element 116 and the reducing element mount 118. Therefore, the depth of cut of each corresponding reducing element 116 is equal to the difference in radial height between an outer surface of the depth control device 120 and the cutting edge 130a. In some examples, the depth control device 120 can be plate-like. In other examples, the depth control device 120 can have an adjustable radial height. In other examples still, the depth control device 120 can have an increasing radial height from a leading edge 138 to a trailing edge 140, where the trailing edge 140 is nearer the reducing element 116 than the leading edge 138.

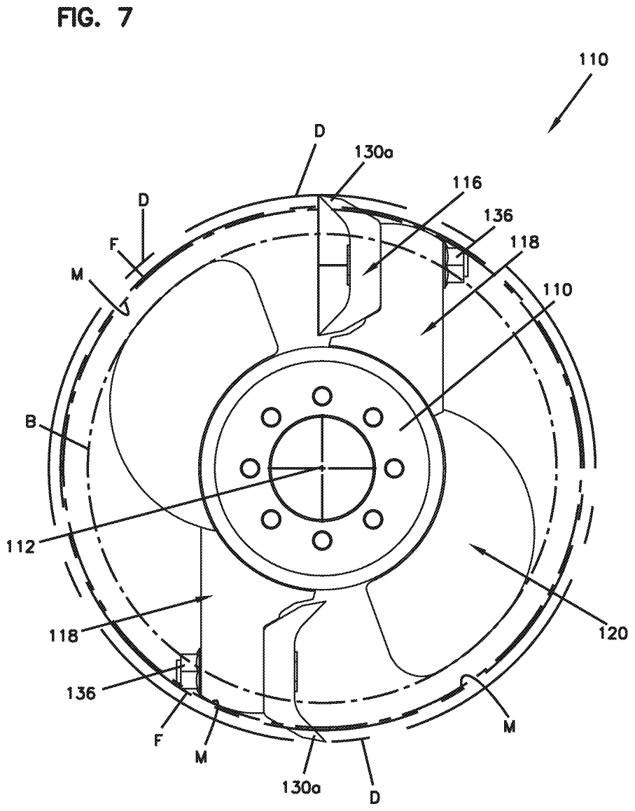

FIG. 7 shows a schematic side view of the rotary reducing component 110. As the rotary reducing component 110 is rotated, the reducing elements 116 define a reducing boundary D. Specifically, the cutting edge 130a defines the reducing boundary D. In some examples, the reducing boundary D has a diameter less than about 56 inches. In other examples, the reducing boundary D has a diameter less than about 56 inches and greater than about 26 inches. In other examples still, the reducing boundary D has a diameter less than or equal to about 26 inches. In some examples, the reducing boundary D has a diameter equal to about 18 inches. The diameter of the reducing boundary D can change over time as the reducing elements 116 wear and are sharpened.

Further, during rotation, a portion of fastener 136 defines a fastener boundary F. The diameter of the fastener boundary F is less than the reducing boundary D. Such a configuration prevents the fastener 136 from first striking a material to be reduced before the reducing element 116. This prevents premature wear on the fastener 136. In some examples, the diameter of the fastener boundary F is about 95% of the diameter of the reducing boundary D. In some examples, the diameter of the fastener boundary F is less than the diameter of the reducing boundary D to allow for sufficient sharpening on the cutting edge 130a.

The reducing element mount 118 defines a mount boundary M that has a diameter less than the diameter of the reducing boundary D. In some examples, the mount boundary M has a diameter less than the diameter of the fastener boundary F.

Finally, the depth control device 120 defines a depth control boundary B that is less the reducing boundary D, mount boundary M, and fastener boundary F.

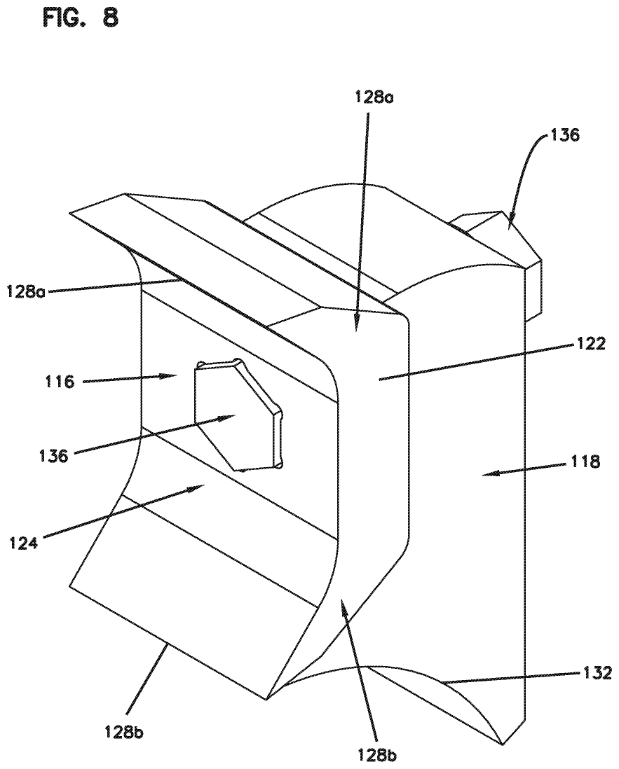

FIG. 8 shows the reducing element 116 mounted to the reducing element mount 118 via the fastener 136.

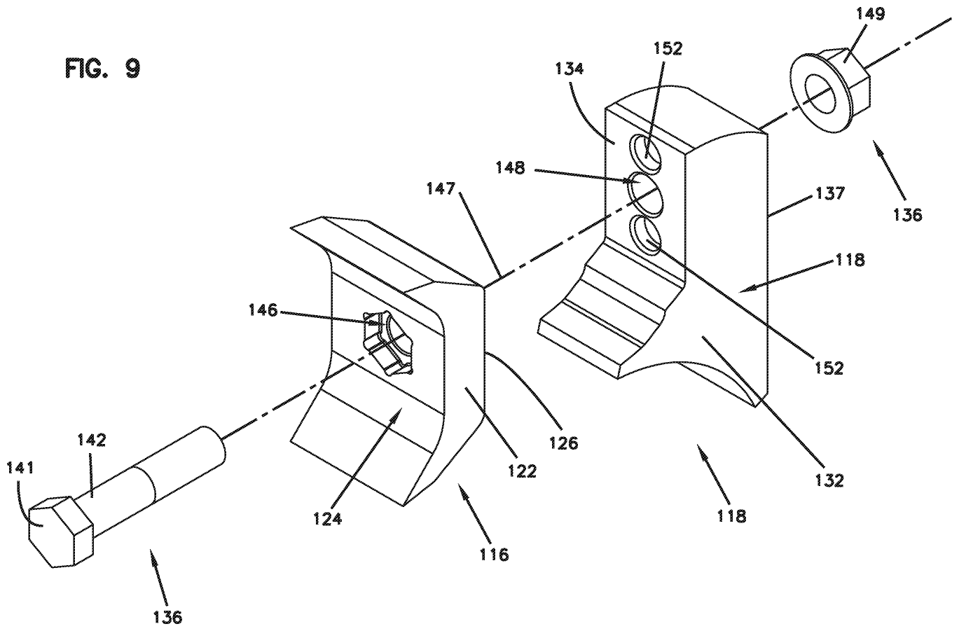

FIG. 9 shows an exploded view of the reducing element 116, the reducing element mount 118, and the fastener 136. As shown, the fastener 136 includes a bolt 142 and a nut 144. The reducing element 116 includes a fastener opening 146 having a central axis 147 that is configured to receive the bolt 142 of the fastener 136. The fastener opening 146 extends though the main body 122 from the leading face 124 to the trailing face 126. In some examples, the fastener opening 146 can have a shape that is configured to receive a head 141 of the bolt 142.

The reducing element mount 118 also includes a fastener opening 148 that is configured to receive the bolt 142 of the fastener 136. The fastener opening 148 extends through the reducing element mount leading face 134 to a trailing face 137.

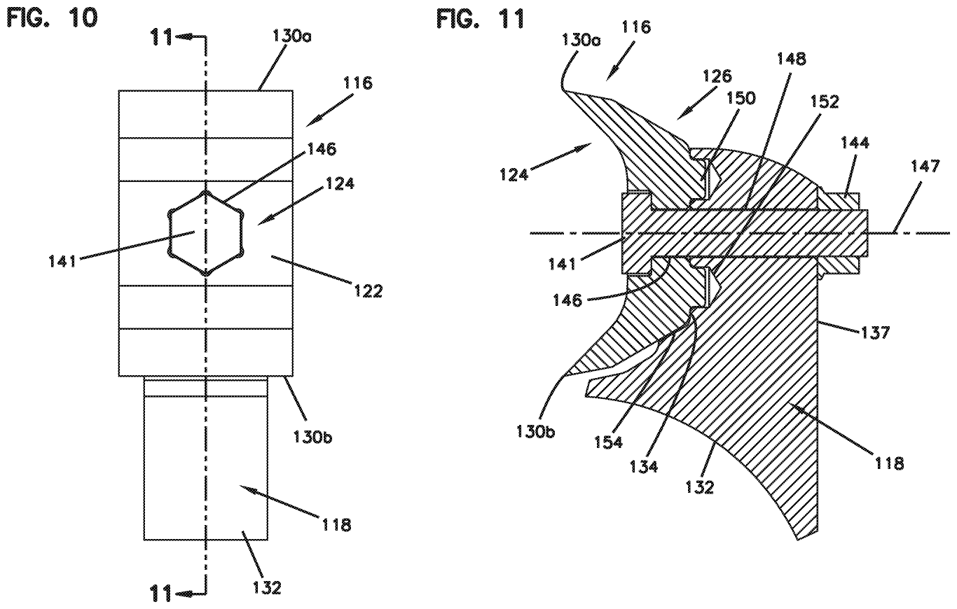

FIG. 10 shows a front view of the reducing element 116 mounted to the reducing element mount 118 via the fastener 136.

FIG. 11 shows a cross sectional view along line 11-11 in FIG. 10. As shown, the fastener 136, specifically the bolt 142, passes through the fastener opening 146 of the reducing element 116 and the fastener opening 148 of the reducing element mount 118. In the depicted embodiment, the bolt 142 is secured to the nut 144 at the trailing face 137 of the reducing element mount. In some examples, the head 141 of the bolt 142 is recessed in the main body 122 of the reducing element 116. In other examples, the head 141 of the bolt 142 is positioned in contact with the trailing face 137 of the reducing element mount and the nut is in contact with the main body 122 of the reducing element 116.

When the reducing element 116 is mounted to the reducing element mount 118, the reducing element mount 118 supports the reducing element 116 in multiple locations. The reducing element 116 can include a pair of projections 150 extending from the trailing face 126. The pair of projections 150 are received and supported by a pair of recesses 152 disposed within the reducing element mount leading face 134 of the reducing element mount 118. In some examples, the projections 150 are cylindrical in shape; however, they can be a variety of different shapes. In some examples, the projections 150 are tapered. In some examples, the recesses 152 are generally cylindrical in shape; however, they can be a variety of different shapes. In some examples, the recesses 152 are tapered.

The reducing element mount 118 can also include a ledge 154 (e.g., a radial load support surface) adjacent the reducing element mount leading face 134 that is configured to support at least a portion of the trailing face 126 of the reducing element 116. In some examples, the ledge 154 is configured to support the reducing element 116 against a force in a radial direction toward the base 132 of the reducing element mount 118, and specifically a force in a radial direction toward the central axis 112 of the rotary reducing component 110, as shown in FIG. 6.

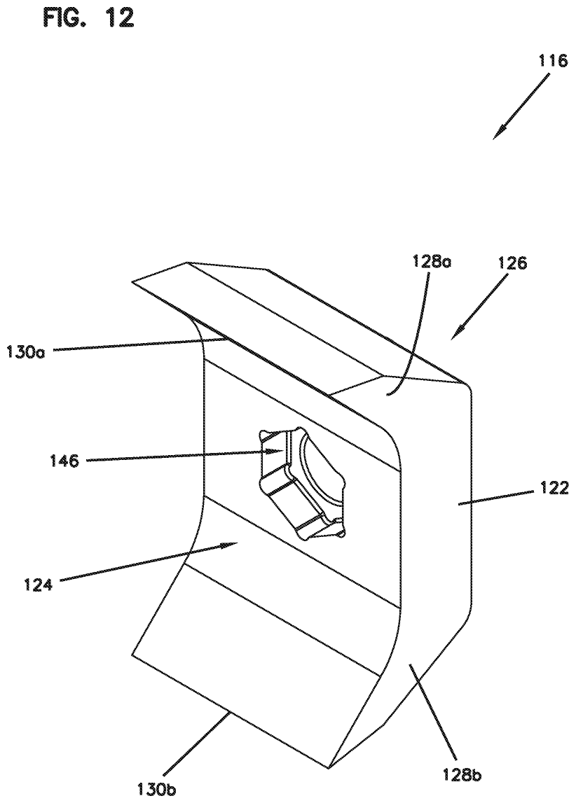

FIG. 12 shows a perspective view of the reducing element 116 from the leading face 124. As shown, the cutting heads 128a, 128b extend away from the main body 122 of the reducing element to create a concave leading face 124.

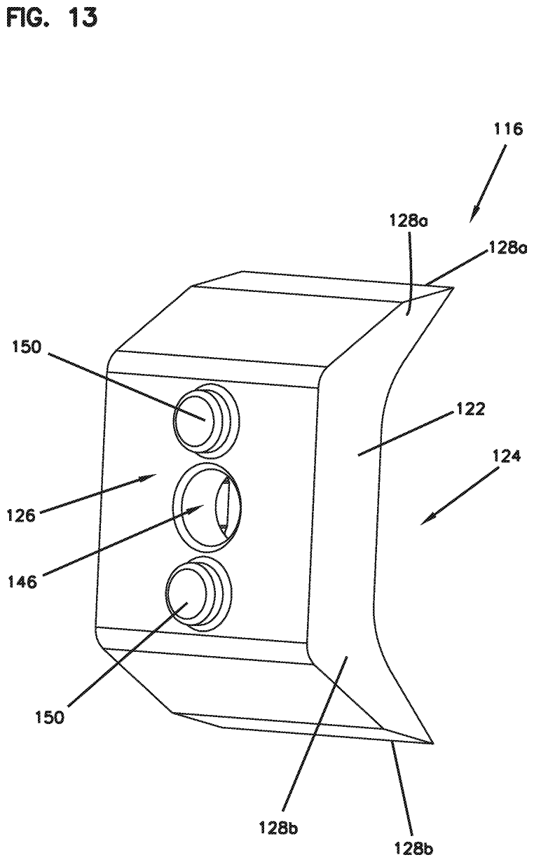

FIG. 13 shows a perspective view of the reducing element 116 from the trailing face 126. As shown, the projections 150 extend from the trailing face 126.

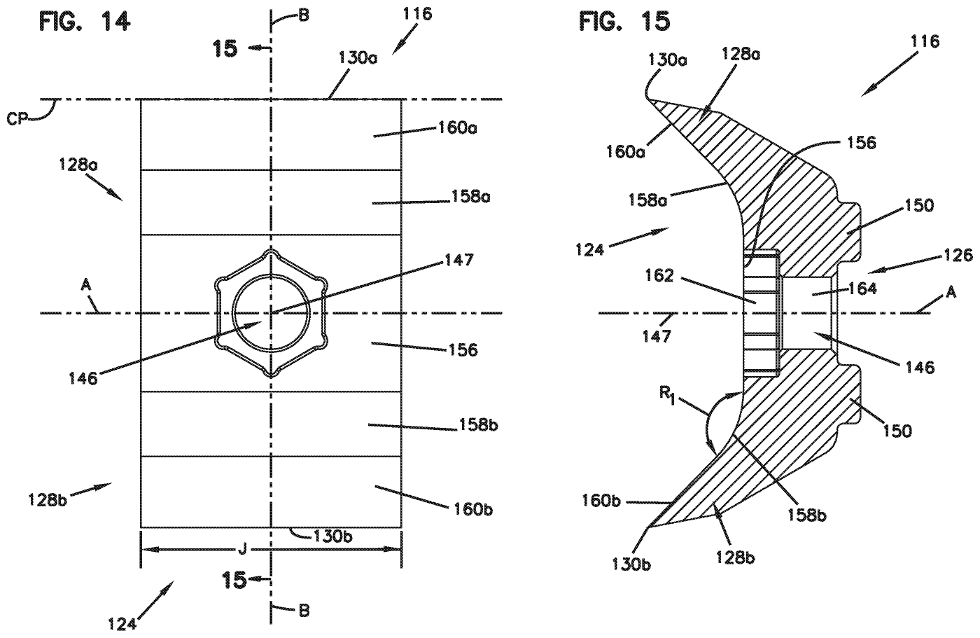

FIG. 14 shows a front view of the reducing element 116 from the leading face 124. FIG. 15 shows a cross section of the reducing element 116 along line 15-15 in FIG. 14. The leading face 124 includes a plurality of distinct surfaces. Specifically, the leading face 124 includes a central surface 156, a first transition surface 158a, a second transition surface 158b, a first rake surface 160a, and a second rake surface 160b. The first transition surface 158a is between the first rake surface 160a and the central surface 156, and the second transition surface 158b is between the second rake surface 160b and the central surface 156. As shown, the first rake surface 160a helps to define the cutting edge 130a, and the second rake surface 160b helps to define the cutting edge 130b. In some examples, the rake and transition surfaces 160a, 160b, 158a, 158b can each have a facetted construction comprising a plurality of sub surfaces. The central surface 156 can have a variety of different shapes and configuration. In some examples, the central surface 156 is planer. In other examples, the central surface 156 can have an assortment of angles and shapes.

The first and second transition surfaces 158a, 158b each have a radius R₁. In some examples, the radius R₁ for both the first and second transition surfaces 158a, 158b is between about 0.25 inches and 1.25 inches. In some examples, the radius R₁ is about 0.5 inches. In some examples, the radius R₁ is about 1.0 inches.

As shown in FIGS. 14-15, a horizontal reference plane A horizontally bisects the central surface 156 and passes through the central axis 147 of the fastener opening 146. In the depicted example, the reducing element 116 is symmetrical about reference plane A. Further, a vertical reference plane B vertically bisects the central surface 156, the first transition surface 158a, the second transition surface 158b, the first rake surface 160a, and the second rake surface 160b and passes through the central axis 147 of the fastener opening 146. In the depicted example, the reducing element 116 is symmetrical about reference plane B.

FIG. 15 also shows the fastener opening 146 having a first passage 162 and a second passage 164. The first passage 162 can be configured to receive the fastener 136 (e.g., the head 141 of the bolt 142 or the nut 144).

As shown in FIGS. 14-15, the cutting edges 130a, 130b are linearly continuous across a width J of the reducing element 116. In some examples, the cutting edges 130a, 130b are linearly discontinuous across the width J of the reducing element 116 but together form a linear cutting plane CP. For example, the reducing element 116 can include a plurality of points that form a linear cutting edge. In other examples still, the reducing element 116 can include angled sub-cutting edges that form a single cutting edge. In such an example, the angled cutting edges can form a leading point or edge(s) or a leading edge(s). For purposes of the present disclosure, the leading point or leading edge in such an example can form the cutting plane CP.

In some examples, the cutting edges 130a, 130b can be formed from the same material as the main body 122. In other examples, the cutting edges 130a, 130b can be formed from a material different from that used to construct the main body 122. In some examples, the cutting edges 130a, 130b can be formed from a single cutting insert or a plurality of cutting inserts. Such inserts can include, but not be limited to, a carbide insert.

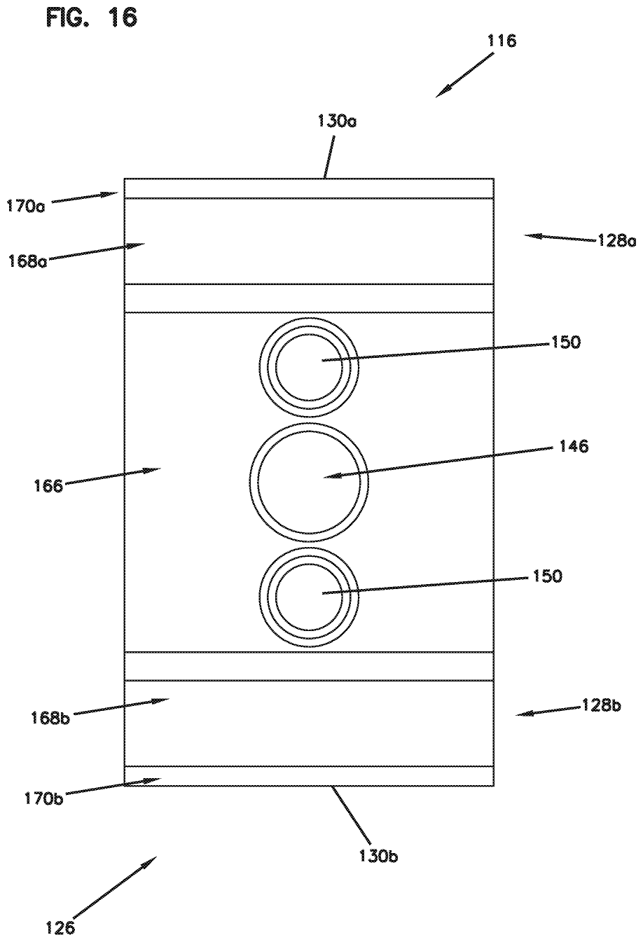

FIG. 16 shows a rear view of the reducing element 116 from the trailing face 126. The trailing face 126 (i.e., a rear face or side) includes a plurality of surfaces including a mounting face 166, a first body surface 168a, a second body surface 168b, a first relief surface 170a and a second relief surface 170b. The first body surface 168a is between and angled with the first relief surface 170a and the mounting face 166, and the second body surface 168b is between and angled with the second relief surface 170b and the mounting face 166.

As shown, the first relief surface 170a helps to define the cutting edge 130a and the second relief surface 170b helps to define the cutting edge 130b. In some examples, the first and second relief surfaces 170a, 170b are configured to be grinded down to sharpen the cutting edges 130a, 130b.

The first and second body surfaces 168a, 168b are configured to be in contact with the ledge 154 of the reducing element mount 118 when the corresponding cutting edge 130a, 130b is not the live edge.

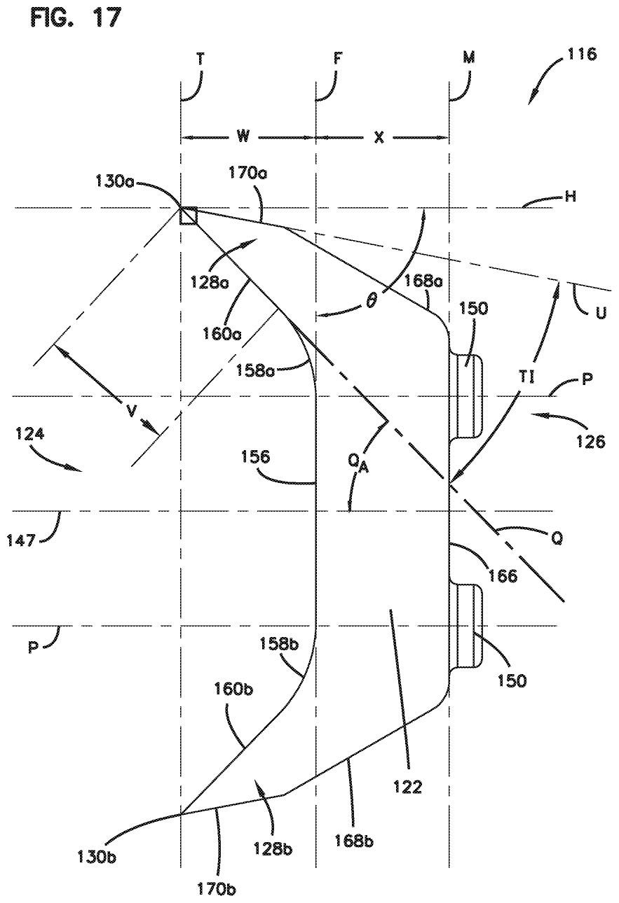

FIG. 17 shows a side view of the reducing element 116. Because cutting heads 128a, 128b are substantially similar, only a set of references and relationships between components of the cutting head 128a are shown. It will be understood that the references and relationships between components at cutting head 128b are substantially similar those at cutting head 128a. A reference plane T is defined by both cutting edges 130a, 130b. A reference plane F is defined by the central surface 156 of the leading face 124. In some examples, the reference plane F is defined generally by central surface 156 of the leading face 124 and is positioned parallel to the reference plane T. A reference plane H is positioned perpendicular to reference plane T.

Reference plane H and reference plane F intersect at an angle θ. In some examples, the angle θ is generally 90 degrees.

A reference plane Q is shown to be defined by the rake surface 160a, and a reference plane U is shown to be defined by the relief surface 170a. Reference plane Q and reference plane U intersect at angle TI. In some examples, angle TI is between about 25 degrees and 40 degrees. In some examples, angle TI is between about 60 degrees and 90 degrees. In some examples, the angle TI is about 35 degrees. In some examples, the angle TI is about 70 degrees. In some examples, Q intersects with the central axis 147 of the fastener opening 146. In some examples, Q intersects with the central axis 147 at an angle QA. In some examples, QA is less than 50 degrees. In some examples, angle QA is about 46 degrees.

The rake surface 160a is shown to have a length V. In some examples, the length V is between about 0.5 inches and 1.2 inches. In other examples, the length V is between about 0.9 inches and 1.1 inches. In other examples still, the length V is about 1.07 inches.

The cutting heads 128a, 128b each extend from the main body 122. As shown, a distance W is between the reference plane T, which passes through each cutting edge 130a, 130b, and the reference plane F that is defined by the central surface 156. In some examples, the distance W is between about 0.80 inches and about 1.2 inches. In some examples, the distance W is about 1.03 inches.

A thickness X of the main body 122 is shown to be defined between the plane F defined by the central surface 156 of the leading face 124 and a plane M defined by the mounting face 166 of the trailing face 126. In some examples, the thickness X is between about 0.8 inches and about 1.2 inches. In other examples, the thickness X is between about 0.9 inches and 1.1 inches. In other examples still, the thickness X is about 1.01 inches.

The projections 150 each include a central axis P. In some examples, the central axes P are generally perpendicular to plane F defined by the central face 156. In some examples, the central axes P are generally perpendicular to plane M defined by the mounting face 166. As shown, plane Q intersects the mounting face 166 at a point between the projections 150, and thereby between the central axes P.

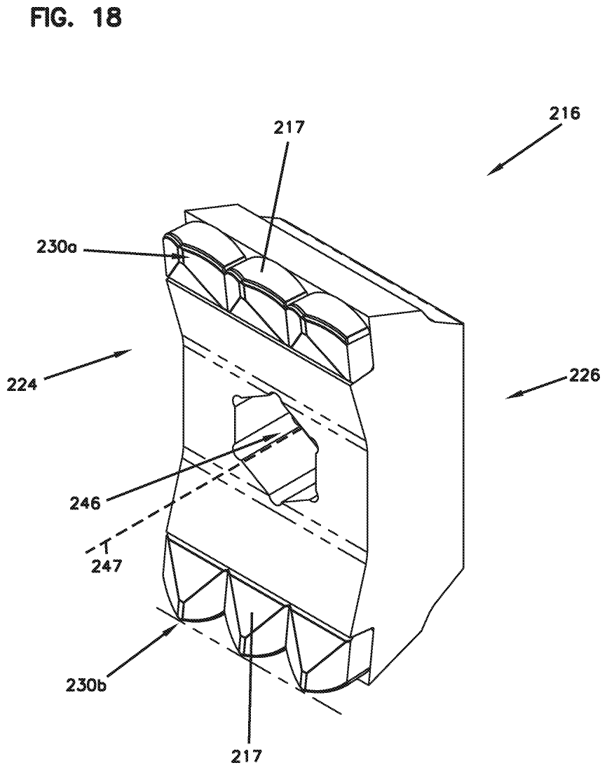

FIG. 18 shows a perspective view of a reversible reducing element 216 according to one embodiment of the present disclosure. The reducing element is substantially similar to the reducing element 116 described above. In some examples, the reducing element 216 is at least partially ornamental in nature and features nonfunctional elements. The reducing element 216 has a leading face 224, a trailing face 226, a first cutting edge 230a, a second cutting edge 230b, and a fastener opening 246. The fastener opening 246 has a central axis 247. The reducing element 216 includes a tip insert 217. In some examples, the reducing element 216 can include a plurality of inserts 217. In some examples, the insert 217 can be a carbide insert. As shown, the tip inserts 217 define the cutting edges 230a, 230b.

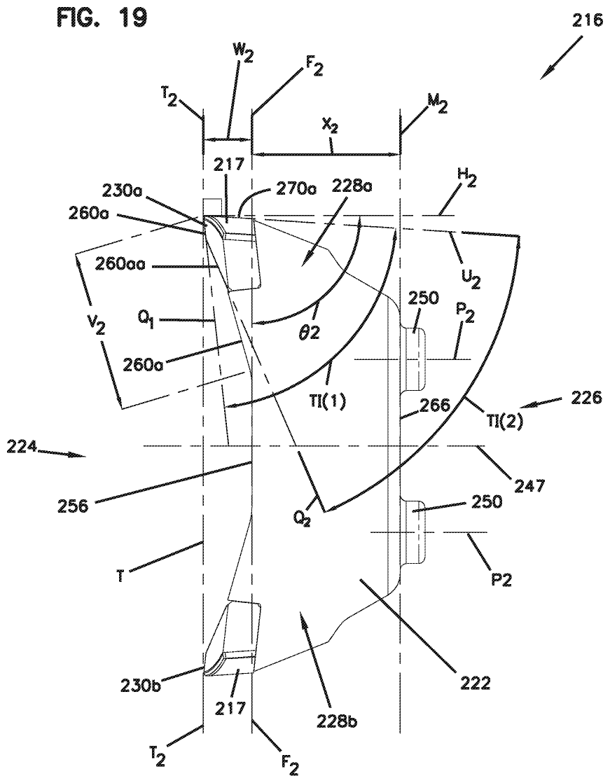

FIG. 19 shows a side view of the reducing element 216. Like the reducing element above, because cutting heads 228a, 228b are substantially similar, only a set of references and relationships between components of the cutting head 228a are shown. A reference plane T2 is defined by both cutting edges 230a, 230b. A reference plane F2 is defined by the central surface 256 of the leading face 224. In some examples, the reference plane F2 is defined generally by central surface 256 of the leading face 224 and is positioned parallel to the reference plane T2. In some examples, the reference plane H2 is positioned perpendicular to reference plane T2. The central surface 256 can have a variety of different shapes and configurations. In some examples, the central surface 256 is planer. In other examples, the central surface 256 can have an assortment of angles and shapes.

Reference plane H2 and reference plane F2 intersect at an angle θ2. In some examples, the angle θ2 is generally 90 degrees.

A reference plane Q1 is shown to be defined by a rake surface 260a. A reference plane Q2 is shown to be defined by a rake surface 260aa, and a reference plane U2 is shown to be defined by a relief surface 270a. Reference plane Q1 and reference plane U2 intersect at angle TI(1). Reference plane Q2 and reference plane U2 intersect at angle TI(2). In some examples, angle TI(1) is between about 60 degrees and 90 degrees. In some examples, angle TI(1) is about 80 degrees. In some examples, angle TI(2) is between about 50 degrees and 70 degrees. In some examples, angle TI(2) is about 63 degrees.

The rake surfaces 260a, 260aa combined have a length V2 to the central surface 256. In some examples, the length V2 is between about 1.0 inches and 2.0 inches. In some examples, the length V2 is about 1.6 inches.

The cutting heads 228a, 228b each extend from a main body 222. As shown, a distance W2 is between the reference plane T2, that passes through the leading most point of cutting edge 230a, 230b, and the reference plane F2 that is defined by the central surface 256. In some examples, the distance W2 is between about 0.25 inches and about 1.0 inches. In some examples, the distance W2 is about 0.5 inches.

A thickness X2 of the main body 222 is shown to be defined between the reference plane F2 defined by the central surface 256 of the leading face 224 and a plane M2 defined by a mounting face 266 of the trailing face 226. In some examples, the thickness X2 is between about 1.0 inches and about 2.0 inches. In other examples, the thickness X2 is about 1.5 inches.

Projections 250 each include a central axis P2. In some examples, the central axes P2 are generally perpendicular to reference plane F2 defined by the central face 256. In some examples, the central axes P2 are generally perpendicular to plane M2 defined by the mounting face 266.

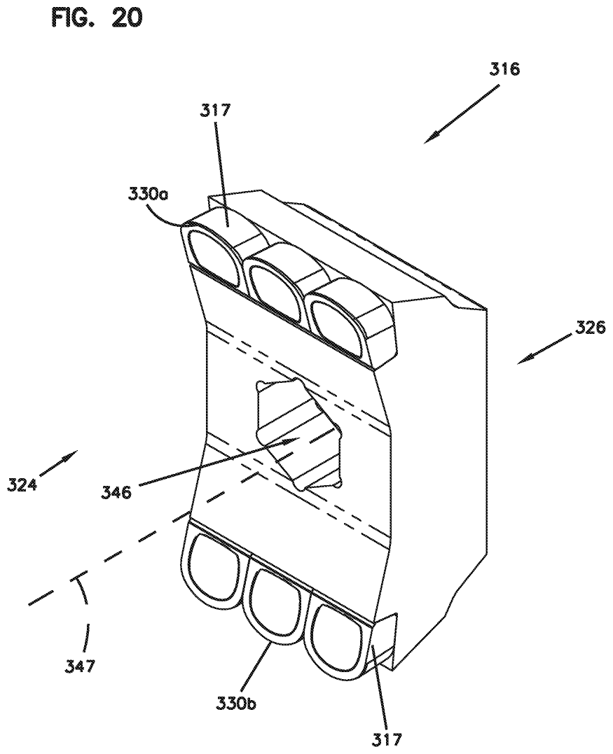

FIG. 20 shows a perspective view of a reversible reducing element 316 according to one embodiment of the present disclosure. The reducing element is substantially similar to the reducing elements 116, 216 described above. In some examples, the reducing element 316 is at least partially ornamental in nature and features nonfunctional elements. The reducing element 316 has a leading face 324, a trailing face 326, a first cutting edge 330a, a second cutting edge 330b, and a fastener opening 346. The fastener opening 346 has a central axis 347. The reducing element 316 includes a tip insert 317. In some examples, the reducing element 316 can include a plurality of inserts 317. In some examples, the insert 317 can be a carbide insert. As shown, the tip inserts 317 define the cutting edges 330a, 330b.

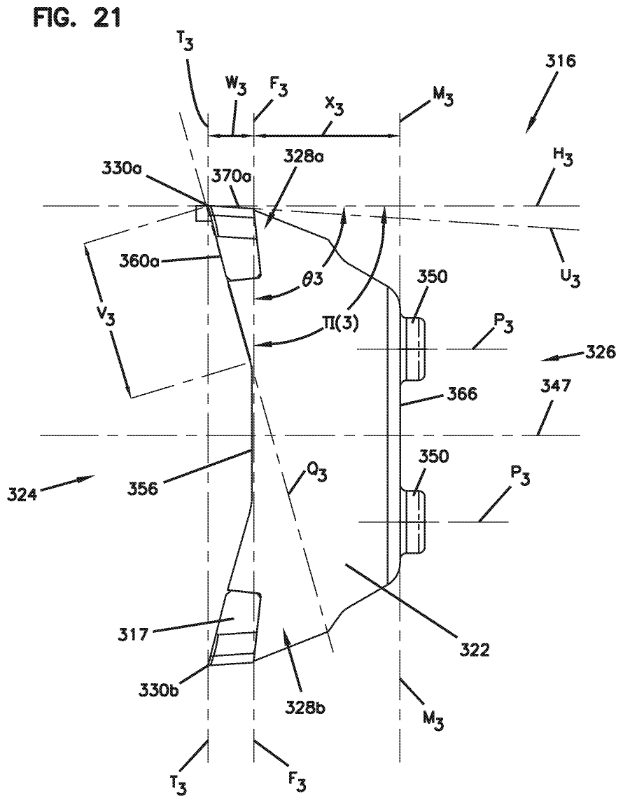

FIG. 21 shows a side view of the reducing element 316. A reference plane T3 is defined by both cutting edges 330a, 330b. A reference plane F3 is defined by the central surface 356 of the leading face 324. In some examples, the reference plane F3 is defined generally by central surface 356 of the leading face 324 and is positioned parallel to the reference plane T3. In the depicted example, a reference plane H3 is positioned perpendicular to reference plane T3. The central surface 356 can have a variety of different shapes and configuration. In some examples, the central surface 356 is planer. In other examples, the central surface 356 can have an assortment of angles and shapes.

Reference plane H3 and reference plane F3 intersect at an angle θ3. In some examples, the angle θ3 is generally 90 degrees.

A reference plane Q3 is shown to be defined by a rake surface 360a and a reference plane U3 is shown to be defined by a relief surface 370a. Reference plane Q3 and reference plane U3 intersect at angle TI(3). In some examples, angle TI(3) is between about 60 degrees and 90 degrees. In some examples, angle TI(3) is about 72 degrees.

The rake surface 360a has a length V3 to the central face 356. In some examples, the length V3 is between about 1.0 inches and 2.0 inches. In some examples, the length V3 is about 1.6 inches.

Cutting heads 328a, 328b each extend from a main body 322. As shown, a distance W3 is between the reference plane T3, that passes through the leading most point of cutting edge 330a, 330b, and the reference plane F3 that is defined by the central surface 356. In some examples, the distance W3 is between about 0.25 inches and about 1.0 inches. In some examples, the distance W3 is about 0.45 inches.

A thickness X3 of the main body 322 is shown to be defined between the reference plane F3 defined by the central surface 356 of the leading face 324 and a plane M3 defined by a mounting face 366 of the trailing face 326. In some examples, the thickness X3 is between about 1.0 inches and about 2.0 inches. In other examples, the thickness X3 is about 1.5 inches.

Projections 350 each include a central axis P3. In some examples, the central axes P3 are generally perpendicular to reference plane F3 defined by the central surface 356. In some examples, the central axes P3 are generally perpendicular to plane M3 defined by the mounting face 266.

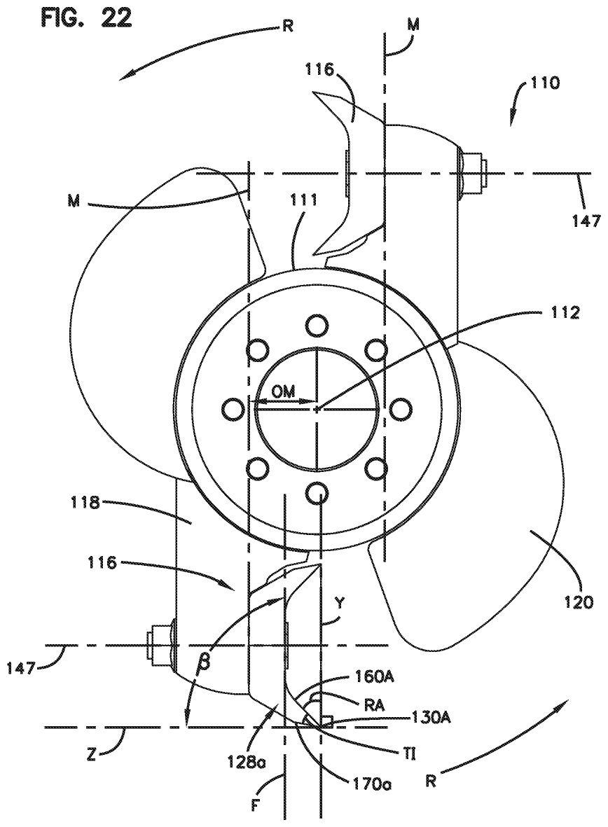

FIG. 22 shows the reducing element 116 mounted to the rotary reducing component 110 via the reducing element mount 118. A reference plane Y intersects with leading most point in the rotation (i.e. reducing) direction R of cutting edge 130a and the central axis 112 of the rotary reducing component 110. A reference plane Z is positioned perpendicular to reference plane Y. Reference plane Z intersects with reference plane F, which is defined by the central surface 156 of the leading face 124, at an angle β. In some examples, angle β is between about 82 degrees and about 102 degrees when the reducing boundary D is equal or less than 26 inches. In other examples, the angle β is between about 79 degrees and about 97 degrees when the reducing boundary D is between about 26 inches and 56 inches. In other examples, the angle β is about 91 degrees regardless of diameter of the reducing diameter D. In some examples, the angle β is about 91 degrees when the reducing boundary D is less than or equal to about 56 inches.

A rake angle RA is defined between the first rake surface 160a and the reference plane Y. The rake angle RA, in one example, can be greater than or equal to 30 degrees. In some examples, the rake angle RA is about 42 degrees.

The mounting plane M is shown to be offset a distance OM from the central axis 112 in a direction opposite of that of the rotation direction R of the rotary reducing component 110 along the central axis 147 of the reducing component 116. In some examples, the mounting plane M is offset a distance that is about 10% of the diameter of the rotary reducing component 110. In some examples, the distance OM that is equal to at least the thickness X of the reducing element (shown in FIG. 17). The mounting plane M is also shown to be offset from the reference plane Y in a direction opposite of that of the rotation direction R of the rotary reducing component 110.

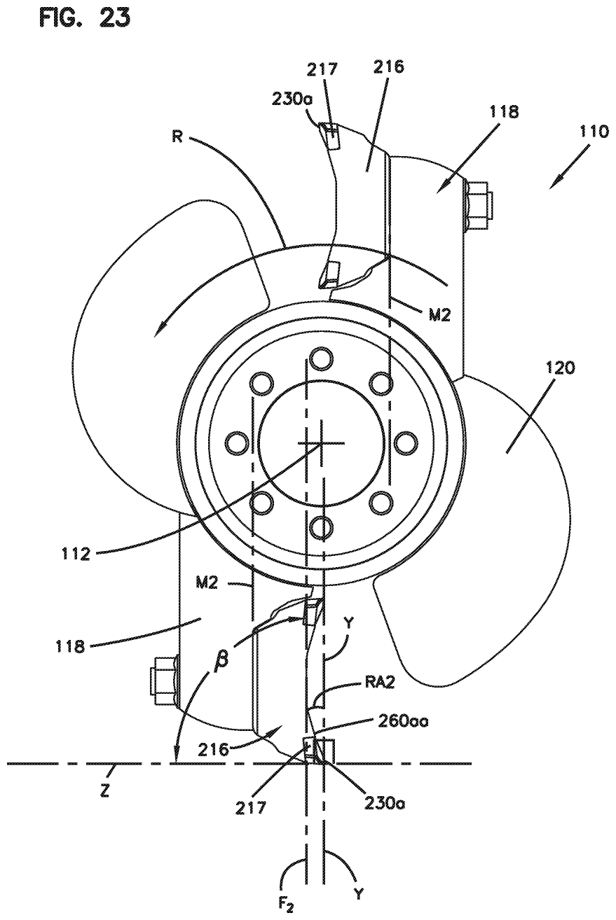

FIG. 23 shows the reducing element 216 mounted to the rotary reducing component 110 via the reducing element mount 118. As shown, the reducing element 216 forms the angle β with reference plane Z and reference plane F2. As described above, in some examples, angle β is between about 82 degrees and about 102 degrees when the reducing boundary D is equal to or less than 26 inches. In other examples, the angle β is between about 79 degrees and about 97 degrees when the reducing boundary D is between about 26 inches and 56 inches. In other examples, the angle β is about 91 degrees regardless of diameter of the reducing diameter D. In some examples, the angle β is about 91 degrees when the reducing boundary D is less than or equal to about 56 inches.

A rake angle RA2 is defined between the first rake surface 260a and the reference plane Y. In some examples, the rake angle RA2 is between about 0 degrees and 20 degrees. In one example, the rake angle RA2 is about 5 degrees. In other examples, the rake angle RA2 is about 14 degrees.

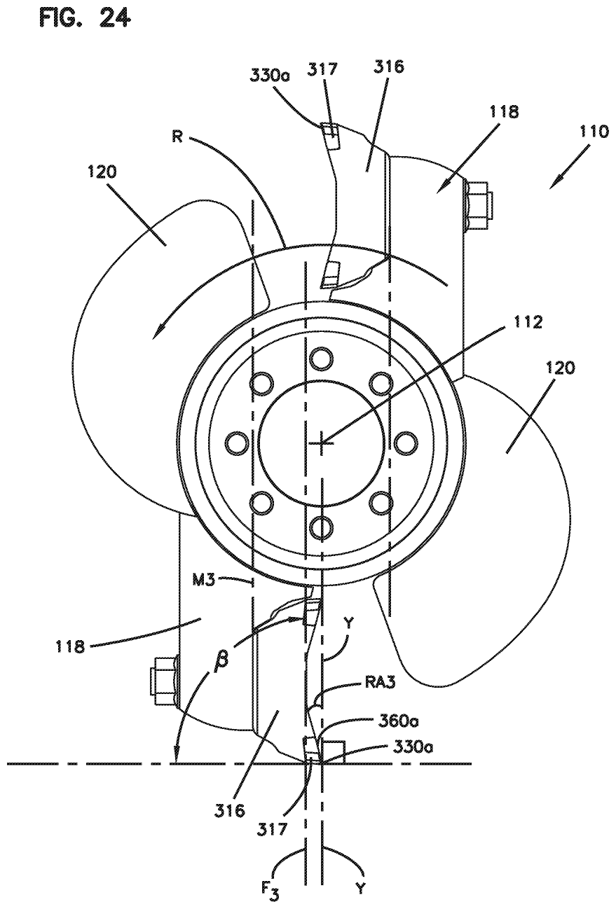

FIG. 24 shows the reducing element 316 mounted to the rotary reducing component 110 via the reducing element mount 118. As shown, the reducing element 316 forms the angle β with reference plane Z and reference plane F3. As described above, in some examples, angle β is between about 82 degrees and about 102 degrees when the reducing boundary D is equal to or less than 26 inches. In other examples, the angle β is between about 79 degrees and about 97 degrees when the reducing boundary D is between about 26 inches and 56 inches. In other examples, the angle β is about 91 degrees regardless of diameter of the reducing diameter D. In some examples, the angle is about 91 degrees when the reducing boundary D is less than or equal to about 56 inches.

A rake angle RA3 is defined between the first rake surface 360a and the reference plane Y. In some examples, the rake angle RA3 is between about 0 degrees and 20 degrees. In one example, the rake angle RA3 is about 5 degrees. In other examples, the rake angle RA3 is about 14 degrees.

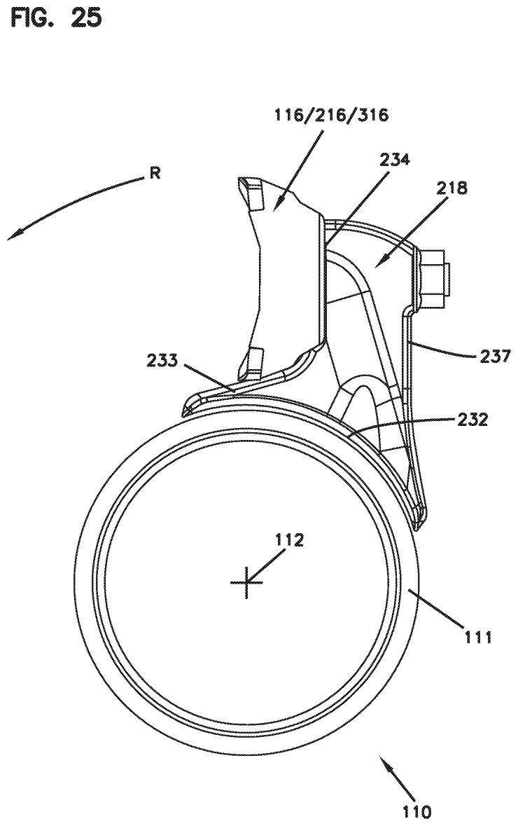

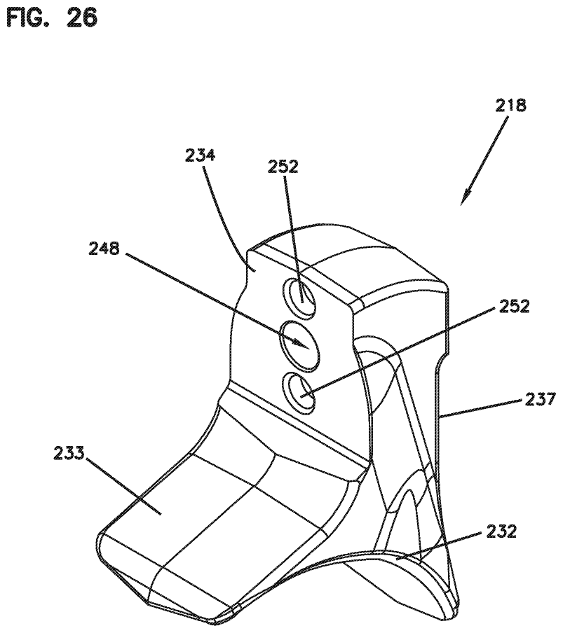

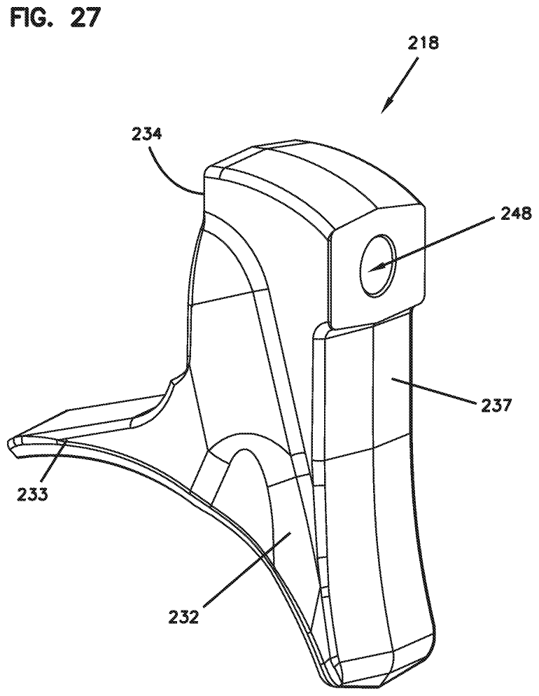

FIGS. 25-27 show a reducing element mount 218 according to one embodiment of the present disclosure. The reducing element mount 218 is substantially similar to the reducing element mount 118 described above. In some examples, the reducing element mount 218 can be forged. Further, the reducing element mount 218 is configured to receive any of the reducing elements 116, 216, 316 described above. Further, as shown in FIG. 25, the reducing element mount 218 is configured to be coupled with the main body 111 of the rotary reducing component 110 at a base 232 and coupled with a reducing element 116, 216, 316 at a reducing element mount leading face 234 via the fastener 136 (shown in FIG. 9). Each reducing element mount 218 extends radially away from the main body 111 so that the reducing element mount leading face 234 faces in the direction of the rotation R.

In the depicted example, the base 232 includes a portion 233 that extends in front of the reducing element 116, 216, 316 in the direction of rotation R when the reducing element mount 218 and reducing element 116, 216, 316 are mounted to the main body 111. In some examples, the portion 233 can include a ramped shape extending opposite the direction of rotation to the leading face 234, being angled away from the main body 111. In some examples, the portion 233 can be configured to support and contact a portion of the reducing element 116, 216, 316.

Like the reducing element mount 118 described above, the reducing element mount 218 includes a fastener opening 248 that is configured to receive the bolt 142 of the fastener 136. The fastener opening 248 extends through the reducing element mount leading face 234 to a trailing face 237.

The reducing element mount 218 can also include a pair of recesses 252 disposed within the reducing element mount leading face 234 of the reducing element mount 218. In some examples, the recesses 252 are generally cylindrical in shape; however, they can be a variety of different shapes. In some examples, the recesses 252 are tapered.

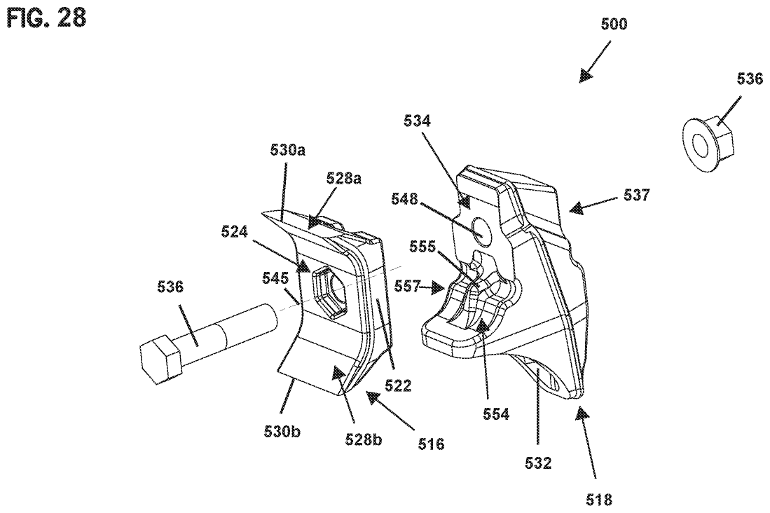

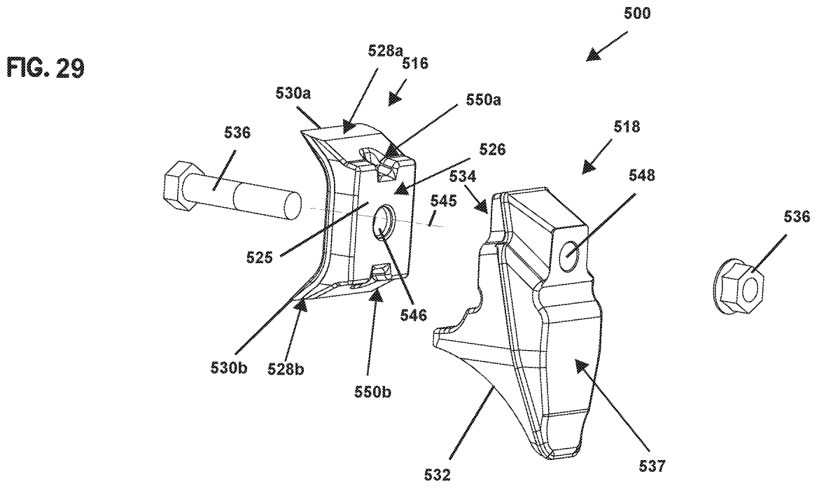

FIGS. 28-29 show exploded views of an assembly 500 that includes a reducing element 516 mountable to a reducing element mount 518 via a fastener 536, according to one example of the present disclosure. Like the reducing element mounts 118, 218, 318 above, the reducing element mount 518 is configured to be mounted to the main body 122 of the rotary reducing component 110.

The reducing element 516 is substantially similar the reducing elements 116, 216, 316 disclosed above. In some examples, the reducing element 516 shares substantially similar geometry with at least one of the reducing elements 116, 216, 316. In some examples, the reducing element 516 is at least partially ornamental in nature and features nonfunctional elements. The reducing element 516 is a relatively sharp, block-like cutter that is suitable for chipping. The reducing element 516 includes a main body 522 that has a leading face 524 (e.g., a front side) and a trailing face 526 (e.g., a rear side). In some examples, the leading face 524 is the face that encounters material to be reduced and a mounting face 525 of trailing face 526 is mated with the reducing element mount 518. The reducing element 516 includes a fastener opening 546 that defines an axis 545. The fastener opening 546 that is configured to receive the fastener 536. In some examples, the mounting face 525 is perpendicular to an axis defined by the fastener opening 546.

In some examples, the reducing element 516 is reversible in that each reducing element includes a pair of cutting heads 528a, 528b. The cutting heads 128a, 128b each include a cutting edge 530a, 530b that are relatively sharp. In some examples, the cutting edges 530a, 530b are equally spaced from the fastener opening 546. In operation, the reducing element 516 can be mounted to the reducing element mount 518 in a first orientation where the cutting edge 530a is positioned to encounter material that will be reduced. In some examples, like reducing element 216, the reducing element 516 can include tip inserts (not shown) that are substantially similar to the tip inserts 217.

The reducing element 516 also includes a pair of mating features 550a, 550b defined in the trailing face 526. Like the projections 150, 250, 350 described above, the mating features 550a, 550b are configured to mate with the reducing element mount 518. The mating features 550a, 550b can be a variety of different shapes. In some examples, the mating features 550a, 550b are at least partially ornamental in nature and feature nonfunctional elements.

The reducing element mount 518 is configured to be mounted to the rotary reducing element 110 at a base 532. The reducing element mount 518 includes a leading face 534 that includes a reducing element mounting face 533 and a ledge 554. The reducing element mounting face 533 is configured to mate with the reducing element 516, specifically the mounting face 525. The reducing element mount 518 also includes an opposite trailing face 537. The reducing element mount 518 also includes a fastener opening 548 that is configured to receive the fastener 536.

The ledge 554 is adjacent the reducing element mounting face 533. Similar to the ledge 154 described above, the ledge 554 can be configured to support at least a portion of the reducing element 516. In some examples, the ledge 554 is configured to support the reducing element 516 against a force in a radial direction toward the base 532 of the reducing element mount 518. In some examples, the ledge 554 can include a mating feature 555 that is configured to mate with one of the mating features 550 of the rotary reducing element 516. In the depicted example, only a single mating feature 550a, 550b at a time mates with the mating feature 555 of the reducing element mount 518. The mating feature 555 can be a variety different shapes. In some examples, the mating features 550a, 550b of the reducing element 516 have the complementary shape of the mating feature 555 of the reducing element mount 518. In other examples, the mating features 550a, 550b of the reducing element 516 are differently shaped from of the mating feature 555 of the reducing element mount 518. In some examples, the mating features 550a, 550b of the reducing element 516 only partially mate with the mating feature 555 of the reducing element mount 518. In some examples, the mating feature 555 is at least partially ornamental in nature and features nonfunctional elements.

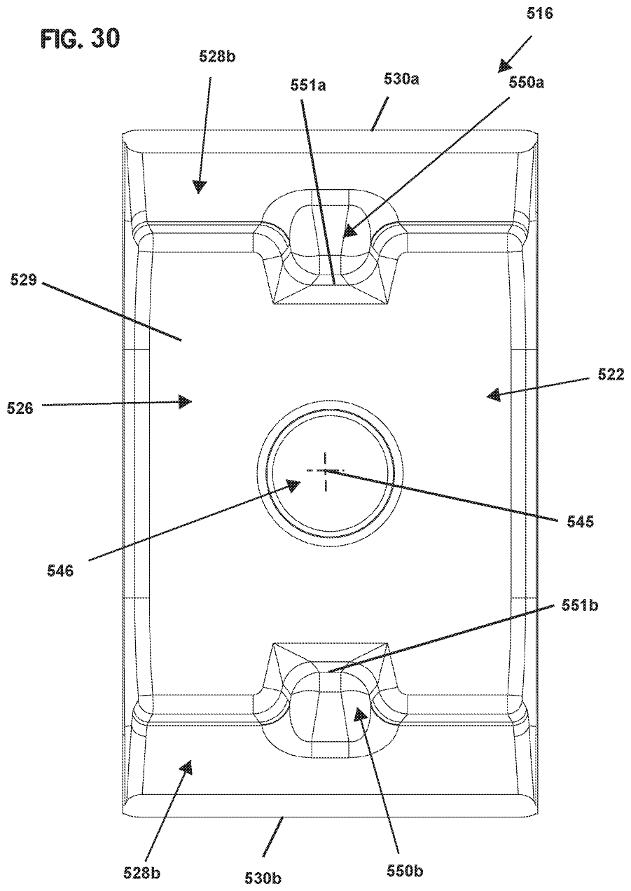

FIG. 30 shows the trailing face 526 of the reducing element 516. The mating features 550a, 550b are shown as concave recesses recessed into the trailing face 526. In some examples, mating features 550a, 550b can have at least one open side. However, in other examples, the mating features 550a, 550b can be convex. In some examples, the mating features 550a, 550b are projections that project from the trailing face 526. In the depicted example, the reducing element 516 includes a pair of mating features 550a, 550b to allow at least one mating feature 550a, 550b to mate with the mating feature 555 of the reducing element mount 518 regardless of which cutting edge 530a, 530b is the live cutting edge. In some examples, a single mating feature 550a, 550b that mates with the mating feature 555 of the reducing element mount 518 corresponds with the cutting head 528a, 528b and cutting edge 530a, 530b that is not being used as the live cutting edge. In some examples, the reducing element 516 can include only a single mating feature 550a, 550b. In some examples, the reducing element 516 can include more than two mating feature 550a, 550b. In some examples, the mating features 550a, 550b are forged. In some examples, the mating features 550a, 550b are machined.

The mating features 550a, 550b are spaced away from the fastener opening 546. In some examples, the mating features 550a, 550b are at least partially defined by the mounting face 525 of the trailing face 526. In some examples, the mating features 550a, 550b are at least partially defined by cutting heads 528a, 528b.

In the depicted example, each mating feature 550a, 550b includes a reducing element mount interfacing surface 551a, 551b that is configured to directly interface with mating feature 555 of the reducing element mount 518. In some examples, the reducing element mount interfacing surfaces 551a, 551b are arcuate. In some examples, the reducing element mount interfacing surfaces 551a, 551b form a concave shaped mating feature 550a.

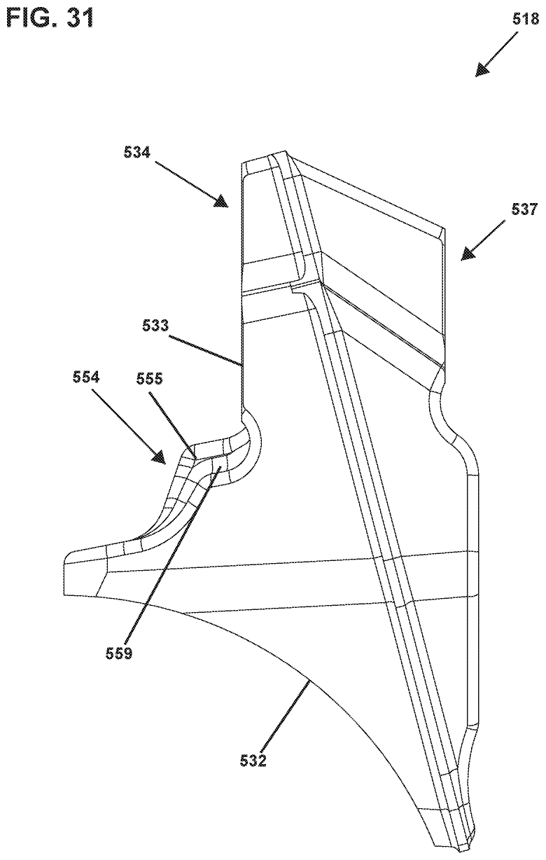

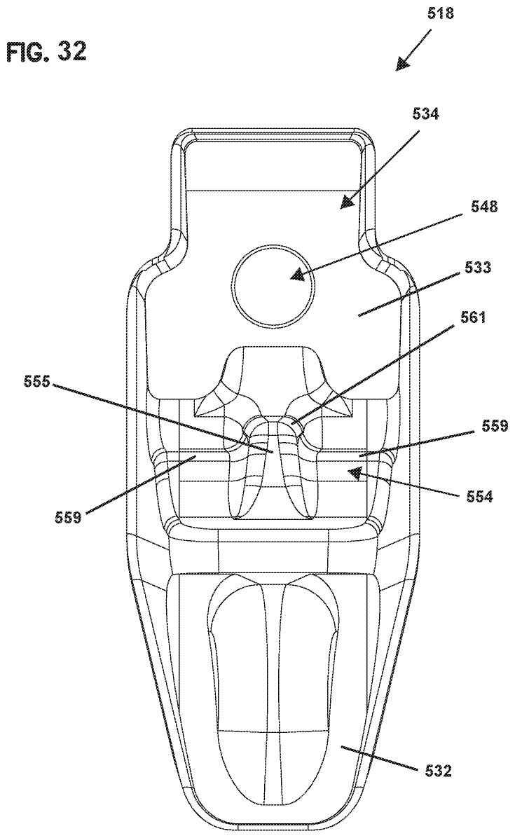

FIG. 31 shows a side view of the reducing element mount 518. FIG. 32 shows a front view of the reducing element mount 518. In the depicted example, ledge 554 includes the mating feature 555 and a support surface 559. In some examples, the mating feature 555 protrudes from the support surface 559. In some examples, the support surface 559 and the mating feature 555 are both configured to interface with the reducing element 516. In some examples, the support surface 559 defines a support surface plane that is generally transverse to a plane defined by the reducing element mounting face 533. In some examples, the reducing element mount 518 can include more than one mating feature 555. While mating feature 555 shown is a projection, the mating feature 555 can also be a recess. In some examples, the mating feature 555 is forged. In some examples, the mating feature 555 is machined.

The mating feature 555 includes a reducing element interfacing surface 561. The reducing element interfacing surface 561 is configured to directly interface with one of the reducing element mount interfacing surfaces 551a, 551b of the mating features 550a, 550b of the reducing element 516. In some examples, the reducing element mount interfacing surface 561 is arcuate. In some examples, the reducing element mount interfacing surface 561 forms a convex shaped mating feature 555.

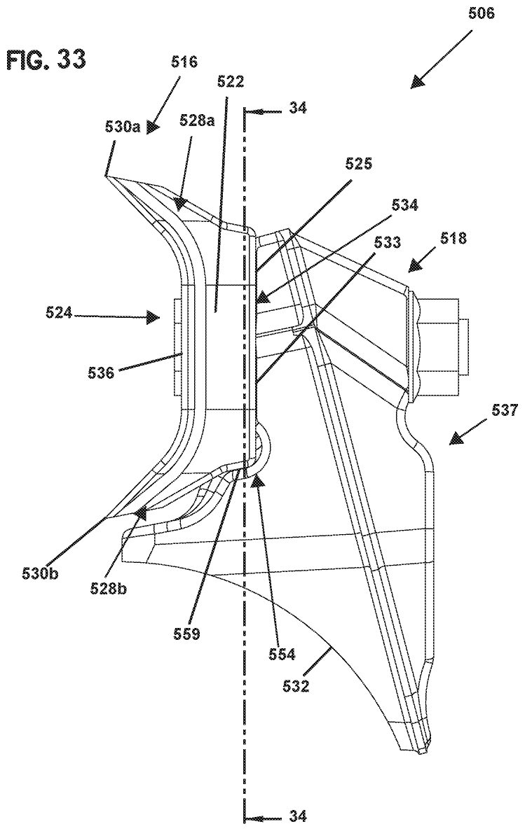

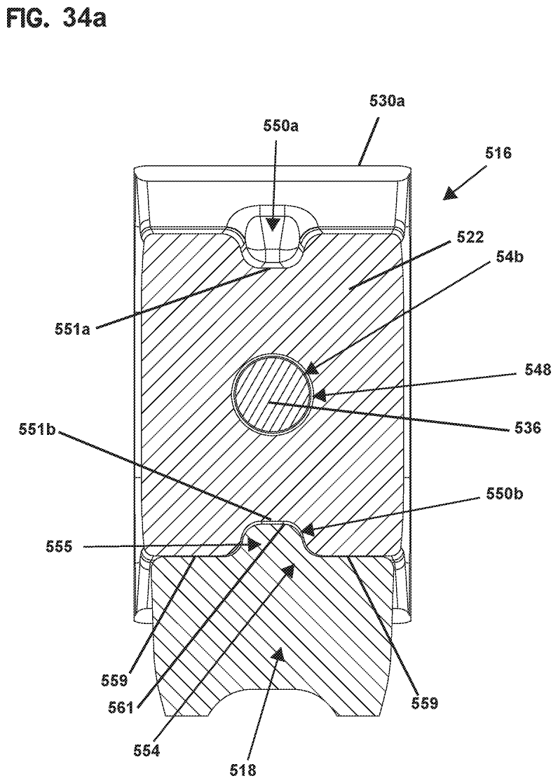

FIG. 33 shows a side view of the assembly 500 with the reducing element 516 mounted to the reducing element mount 518 via the fastener 536. The mounting face 525 of the reducing element 516 is mated with the leading face 534 of the reducing element mount 518.

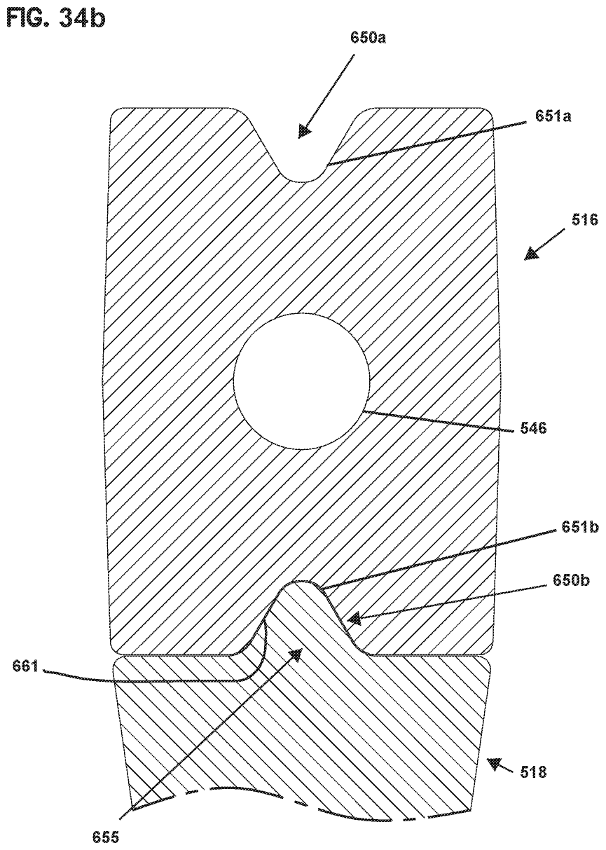

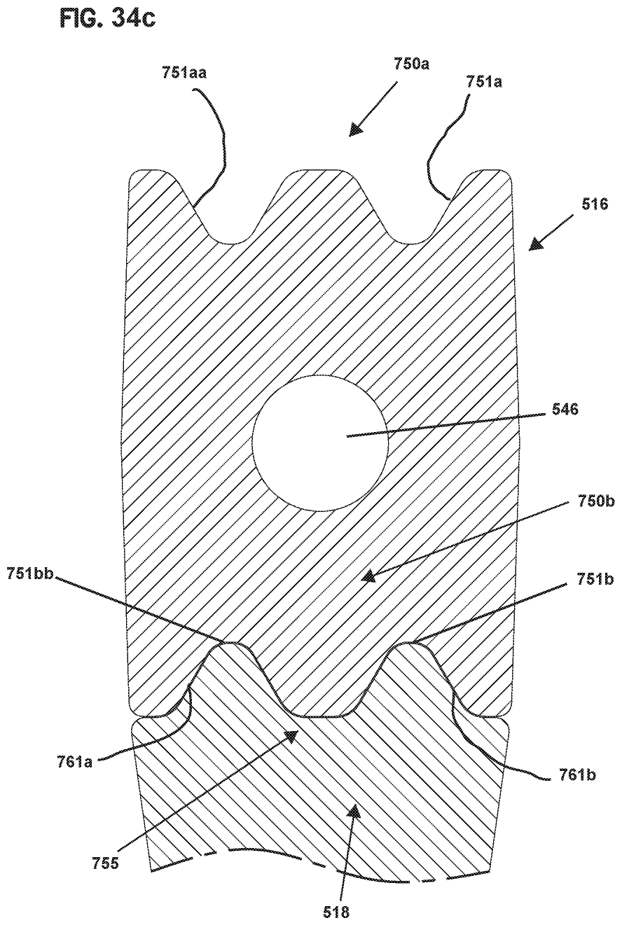

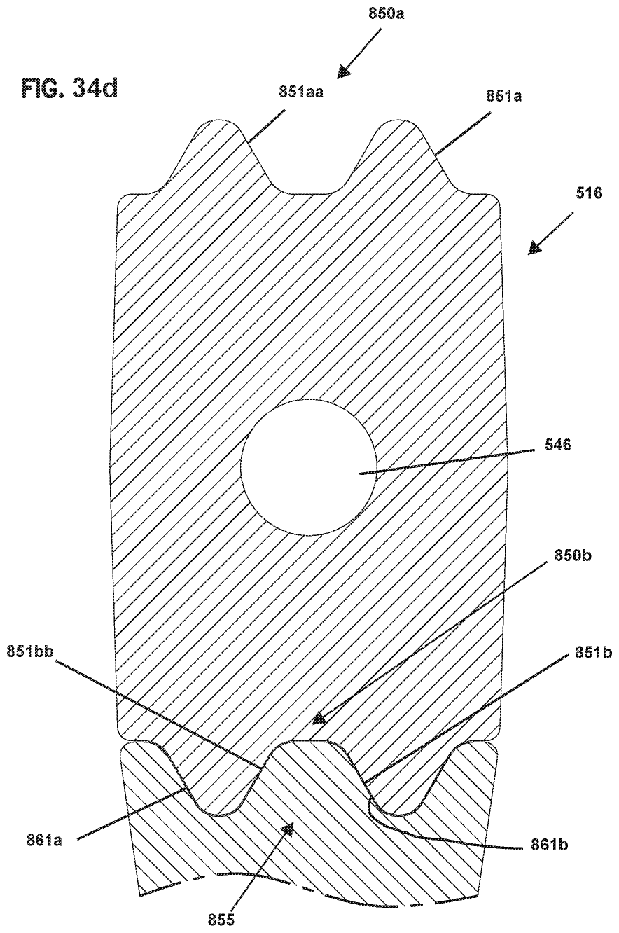

FIG. 34a shows a cross-sectional view of the assembly 500 along line 34-34 of FIG. 33. As shown, the reducing element interfacing surface 561 of the reducing element mount 518 is mated with the reducing element mount interfacing surface 551b of the reducing element 516.

FIG. 34b shows another example of a mating feature 655 of the reducing element mount 518 that has a reducing element mount interfacing surface 651a, 651b. In some examples, the mating feature 655 of the reducing element mount 518 is a projection and the mating features 650a, 650b of the reducing element 516 are recesses. In other examples, the mating feature 655 of the reducing element mount 518 is a recess and the mating features 650a, 650b of the reducing element 516 are projections.

As shown, the reducing element interfacing surface 661 of the reducing element mount 518 is mated with the reducing element mount interfacing surface 651b of the reducing element 516. As shown, the reducing element interfacing surface 661 and the reducing element mount interfacing surface 651b have generally triangular cross-sections. In some examples, the mating features 650a, 650b, 655 are at least partially ornamental in nature and feature nonfunctional elements.

FIG. 34c shows another example of a mating feature 755 of the reducing element mount 518 and mating features 750a, 750b of the reducing element 516. In the depicted example, each mating feature 750a, 750b includes a pair of reducing element mount interfacing surfaces 751a, 751aa/751b, 751bb. In the depicted example, the mating feature 755 is also shown to include a pair of reducing element interfacing surfaces 761a, 761b. In some examples, the reducing element 516 and the reducing element mount 518 have the same number of the interfacing surfaces. In other examples, the reducing element 516 and the reducing element mount 518 have different numbers of interfacing surfaces. In some examples, the mating feature 755 of the reducing element mount 518 includes at least one projection and the mating features 750a, 750b of the reducing element 516 include at least one recess. In other examples, the mating feature 755 of the reducing element mount 518 includes at least one recess and the mating features 750a, 750b of the reducing element 516 include at least one projection. In some examples, the mating feature 755 of the reducing element mount 518 includes at least one recess and at least one projection and the mating features 750a, 750b of the reducing element 516 includes at least one projection and at least one recess. In some examples, the mating feature 755 of the reducing element mount 518 includes a pair of projections and the mating features 750a, 750b of the reducing element 516 includes a pair of recesses. As shown, each reducing element interfacing surface 761a, 761b of the reducing element mount 518 is mated with each reducing element mount interfacing surface 751b, 751bb of the reducing element 516. As shown, the reducing element interfacing surfaces 761a, 761b and the reducing element mount interfacing surfaces 751b, 751bb have a generally triangular cross-sections. In some examples, the mating features 750a, 750b, 755 are at least partially ornamental in nature and feature nonfunctional elements.

FIG. 34d shows another example of a mating feature 855 of the reducing element mount 518 and mating features 850a, 850b of the reducing element 516. In the depicted example, each mating feature 850a, 850b includes a pair of reducing element mount interfacing surfaces 851a, 851aa/851b, 851bb. In some examples, the mating feature 855 of the reducing element mount 518 includes a pair of recesses and the mating features 850a, 850b of the reducing element 516 include a pair of projections. In some examples, the mating features 850a, 850b, 855 are at least partially ornamental in nature and feature nonfunctional elements.

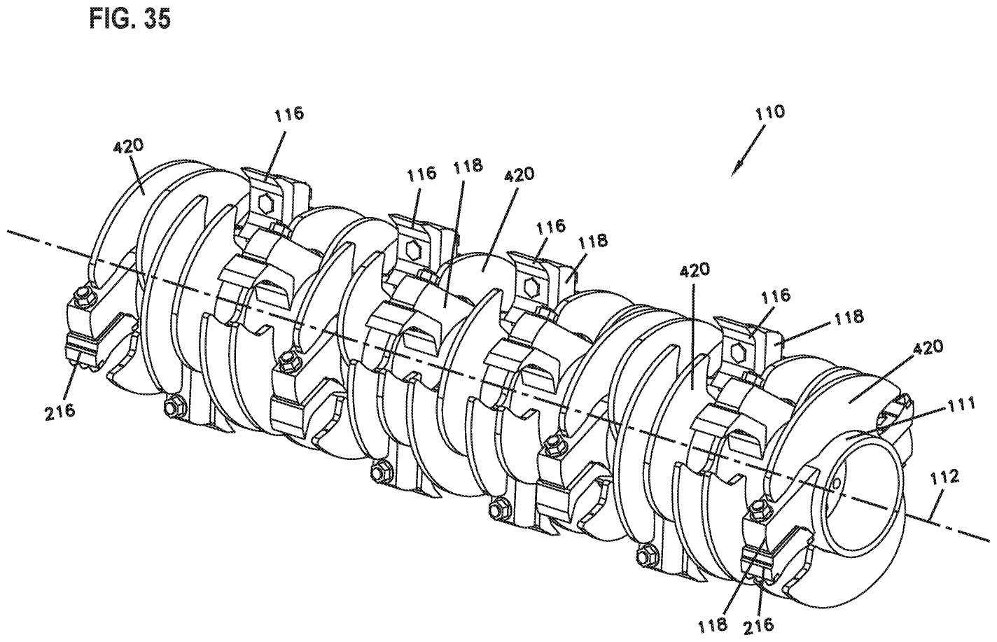

FIG. 35 shows another perspective view of the rotary reducing component 110. Like in FIG. 4 above, the reducing elements 116 are mounted to the reducing element mounts 118 that are mounted to a main body 111. Like above, the depicted rotary reducing component 110 includes 24 reducing elements 116 spaced along the length of the main body 111 of the rotatory reducing component 110. The rotary reducing component 110 includes a plurality of depth control devices 420 that are configured to both aid in preventing the rotary reducing component from becoming jammed during operation and to aid in controlling the size of a material chip created by the reducing components 116 during operation by limiting their depth of cut during operation. While reducing elements 116 are shown and used in the following description, reducing elements 216, 316 and a variety of other different types of reducing elements can be utilized with the depth control devices 420.

Each depth control device 420 is paired with a reducing element 116. Specifically, each depth control device 420 is mounted to the main body 111 of the rotary reducing component 110 circumferentially adjacent each reducing element 116 and reducing element mount 118 so that, during rotation of the rotary reducing component 110, the depth control device 420 passes by a point prior to the reducing element 116 and the reducing element mount 118. In some examples, each depth control device 420 can be plate-like. In other examples, each depth control device 420 can include a plurality of individual components.

In some examples, each depth control devices 420 can be one of a plurality of different types and shapes. For example, each depth control devices 420 can have one of a plurality of three different types to maximize the performance of the rotary reducing component 110. In some examples, the depth control devices 420 can be configured to have a minimal radial height at portions of the depth control devices 420 that are immediately axially adjacent reducing elements 116 of which the respective depth control device 420 is not circumferentially adjacent.

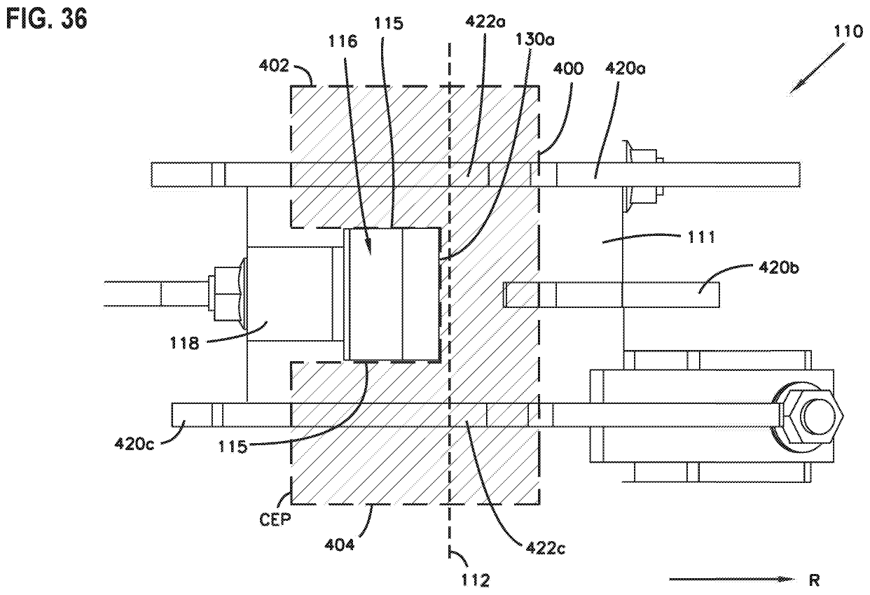

FIG. 36 shows a schematic view of an example arrangement of the depth control devices 420 on the main body 111 of the rotary reducing component 110 surrounding a single reducing element 116. FIG. 36 is meant to be schematic and illustrative of the arrangement around a single reducing element 116. As shown, a depth control device 420b is circumferentially aligned with the reducing element 116. In some examples, the depth control device 420b can be centered with the reducing component 116. Further, depth control devices 420a, 420c are shown positioned axially adjacent on the main body 111 from the reducing component 116. Specifically, the reducing element 116 and the associated depth control device 420b are shown positioned between the depth control devices 420a, 420b.

A chip evacuation pocket CEP is schematically shown with dashed lines surrounding the reducing element 116. The chip evacuation pocket CEP is a pocket in which the chips move away from the reducing element 116 during operation of the rotary reducing component 110. The chips are formed from material which the reducing element 116 contacts (i.e., reduces). To ease chip evacuation away from the reducing element 116, it is advantageous to have a chip evacuation pocket as large and as open as possible. However, it is also imperative to maintain depth control so that the reducing element 116 can function optimally and in a protected manner.

In the depicted example, the chip evacuation pocket CEP is generally U-shaped. Specifically, the chip evacuation pocket CEP has a leading most boundary 400 in the rotation direction R that is defined by at least the depth control device 420b. Side boundaries 402 and 404 extend past the depth control devices 420a, 420c in opposite axial directions from sides 115 of the reducing element 116. In some examples, the depth control structures 420a, 420b have configurations in which pocket portions 422a, 422c of the depth control devices 420a, 420c that correspond with the side boundaries 402, 404 of the chip evacuation pocket CEP and have radial heights that are substantially reduced radial heights to allow for proper chip movement away from the reducing element 116. In some examples, all reducing elements 116 positioned on the main body 111 of the rotary reducing component 110 have a similar chip evacuation pocket CEP as shown in FIG. 36. In some examples, the reducing elements 116 that are positioned immediately adjacent the ends of the main body 111 have at least a portion of the chip evacuation pocket CEP associated with them. The chip evacuation pocket also extends radially away from the main body 111 to the cutting edge 130a.

On the complete rotary reducing component 110, the depth control devices 420a, 420c also each circumferentially align with reducing elements 116 positioned on the main body 111. Therefore, successive axially adjacent depth reducing devices 420 are each circumferentially aligned with a reducing element 116 while also providing pocket portions 422 that are axially adjacent successive axially adjacent reducing elements 116. Such an arrangement maximizes the size of the chip evacuation pocket CEP and provides depth control.

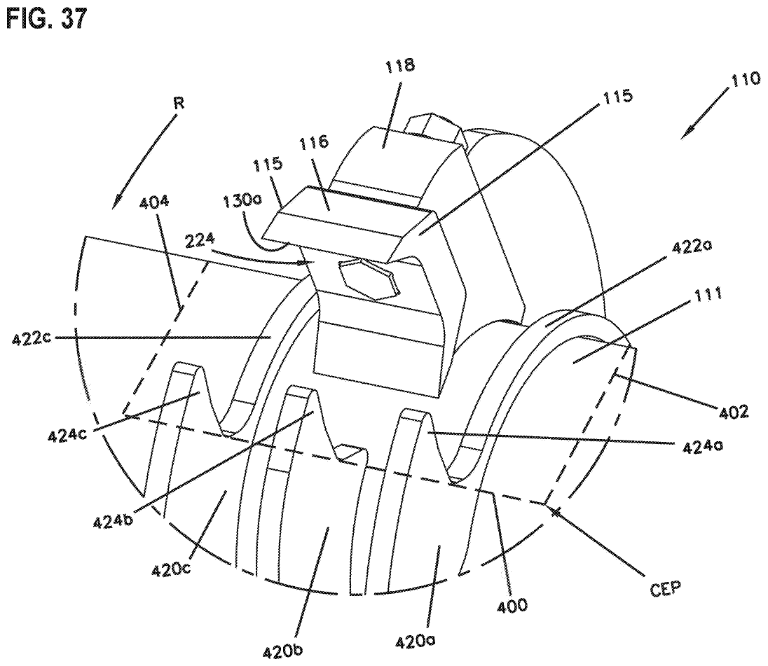

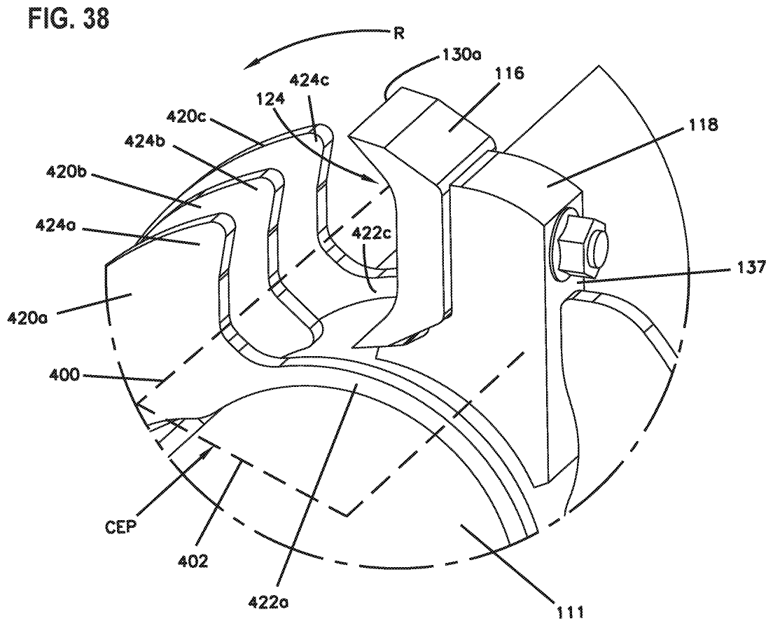

FIG. 37 shows a front perspective view of a first example of the arrangement shown in FIG. 36. FIG. 38 shows a rear perspective view of the first example of the arrangement shown in FIG. 36. As shown, the depth control devices 420a, 420c are axially spaced along the main body 111 from the sides 115 of the reducing element 116 and the depth control device 420b. Further, the pocket portions 422a, 422c of the depth control devices 420a, 420c are shown to have a radial heights from the main body 111 that are substantially less than a radial height of the reducing element 116.

In the first example shown in FIGS. 37 and 38, the leading most boundary 400 of the chip evacuation pocket CEP is defined by depth extensions 424a, 424b, 424c of the depth control devices 420a, 420b, 420c. In some examples, the depth extensions 424a, 424b, 424c have radial heights from the main body 111 greater than the pocket portions 422a, 422c. In some examples, the depth extensions 424a, 424b, 424c have radial heights equal to or greater than half the radial height of the reducing element 116. The depth extensions 424a, 424b, 424c can aid in protecting the reducing element 116 and aid in reducing the depth of cut by the cutting edge 130a of the reducing element 116. In some examples, the depth extensions 424a, 424b, 424c can have hook-like configurations and be circumferentially spaced from the leading face 124 of the reducing element 116. In some examples, the depth extensions 424a, 424b, 424c have equal radial heights. In other examples, the depth extensions 424a, 424b, 424c have varying radial heights.

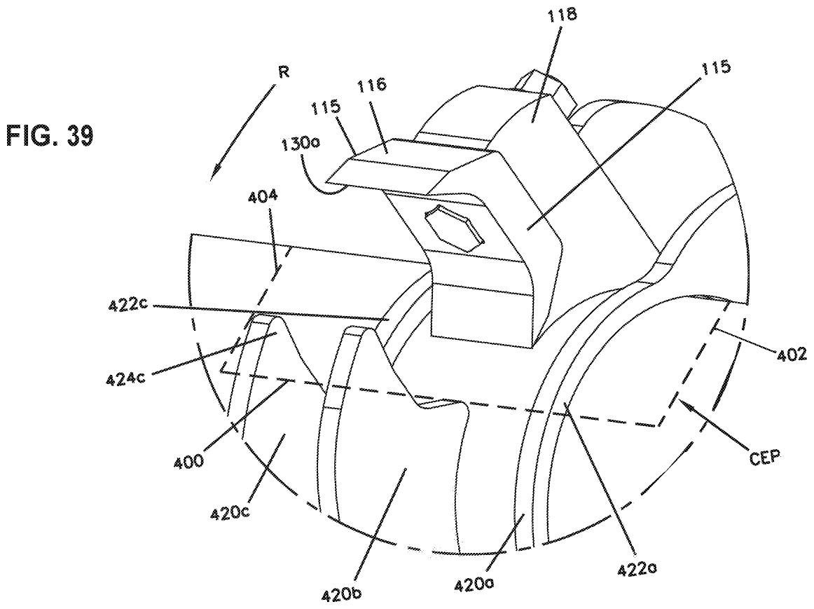

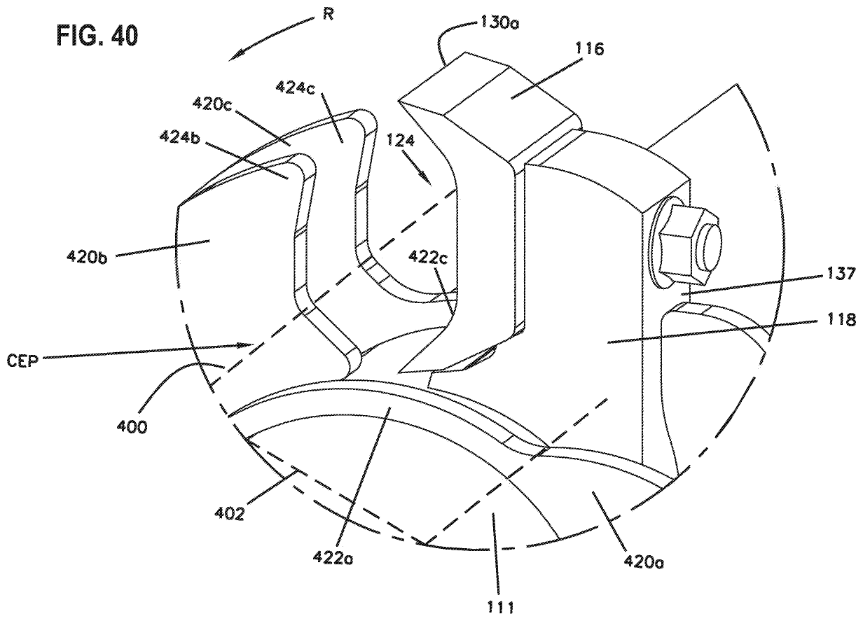

FIG. 39 shows a front perspective view of a second example of the arrangement shown in FIG. 36. FIG. 40 shows a rear perspective view of the second example of the arrangement shown in FIG. 36. What differs from the first example is that, in the second example shown in FIGS. 39 and 40, the leading most boundary 400 of the chip evacuation pocket CEP is defined by depth extensions 424a, 424b of the depth control devices 420a, 420b. As shown, the pocket portion 422c of the depth control device 420c is positioned axially adjacent the depth extensions 424a, 424b. Alternatively, the leading most boundary 400 of the chip evacuation pocket CEP can be defined by depth extensions 424b, 424c of the depth control devices 420b, 420c, and the pocket portion 422a of the depth control device 420a is positioned axially adjacent the depth extensions 424b, 424c.

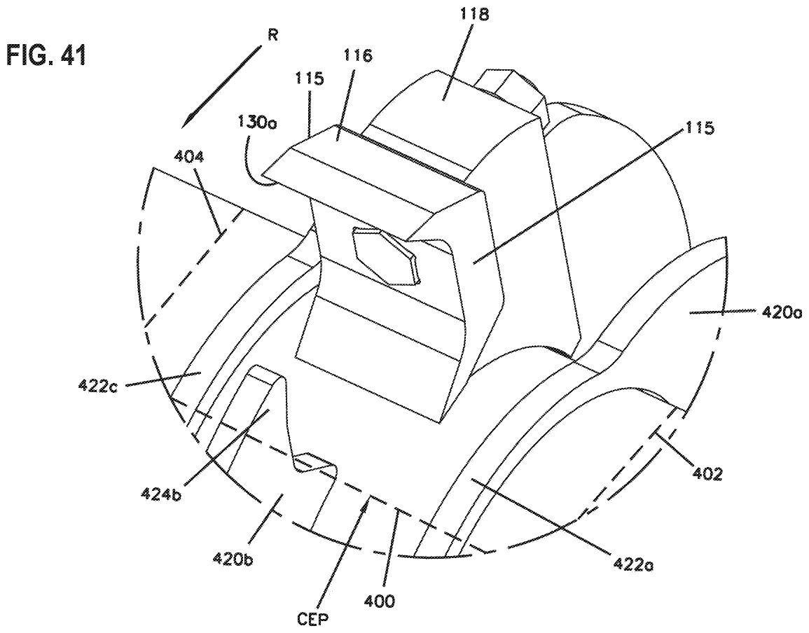

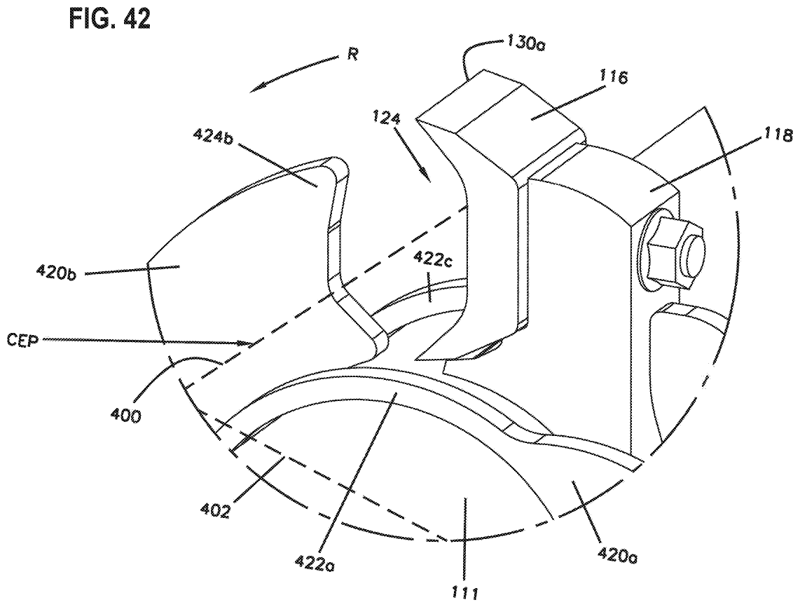

FIG. 41 shows a front perspective view of a third example of the arrangement shown in FIG. 36. FIG. 42 shows a rear perspective view of the third example of the arrangement shown in FIG. 36. What differs from the first and second examples is that, in the third example shown in FIGS. 41 and 42, the leading most boundary 400 of the chip evacuation pocket CEP is defined only by the depth extension 424b of the depth control device 420b. As shown, the pocket portions 422a, 422c of the depth control devices 420a, 420c are positioned axially adjacent the depth extension 424b.

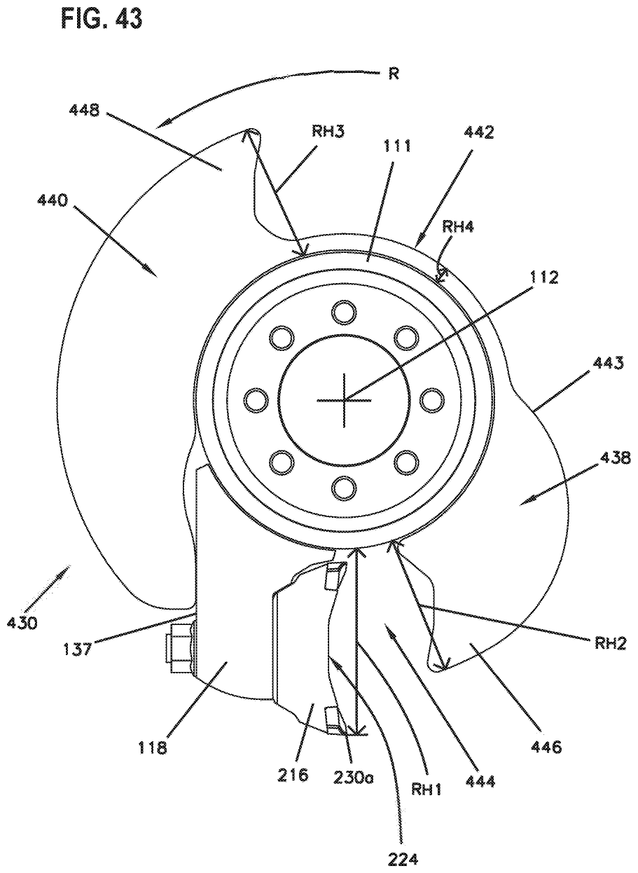

FIGS. 43-45 show side views of example depth control devices 430, 432, 434. The depth control devices 430, 432, 434 can be disposed on the main body 111 in a variety of different orders and patterns. Specifically, the depth control devices 430, 432, 434 can be used as depth control devices 420a, 420b, and 420c in a variety of different orders, depending on the position of the reducing elements on the main body 111 of the rotary reducing component 110. In the example shown in FIGS. 37-42, the depth control device 430 corresponds with depth control device 420a, the depth control device 432 corresponds with depth control device 420b, and the depth control device 434 corresponds with depth control device 420c.

FIG. 43 shows the depth control device 430 positioned circumferentially adjacent an example reducing element 216. Reducing elements 116 and 316 can also be used. The reducing element 216 has a radial height of RH1 from the main body 111. The depth control device 430 includes a leading depth control portion 438, a trailing depth control portion 440, a pocket portion 442 between the leading and trailing depth control portions 438, 440, and a reducing element gap 444 between the leading and trailing depth control portions 438, 440.

The leading depth control portion 438 is positioned in front of the reducing component 216 in the direction of rotation R. The leading depth control portion 438 includes a depth extension 446 that has a radial height RH2 from the main body 111. In some examples, the leading depth control portion 438 has a consistent radial height. In other examples, the leading depth control portion 438 has a decreasing height in the direction of rotation R. In other examples, the leading depth control portion 438 has an increasing height in the direction of rotation R

The trailing depth control portion 440 is positioned behind the reducing component 216 in a direction opposite the direction of rotation R. The trailing depth control portion 440 includes a depth extension 448 that has a radial height RH3 from the main body 111. In some examples, the trailing depth control portion 440 has a consistent radial height. In other examples, the trailing depth control portion 440 has a decreasing height in the direction of rotation R. In other examples, the trailing depth control portion 440 has an increasing height in the direction of rotation R.

The pocket portion 442 is positioned between the leading depth control portion 438 and the trailing depth control portion 440. In some examples, the pocket portion 442 has a radial height RH4 from the main body 111. In some examples, the depth control device 430 is constructed of only the leading and trailing depth control portions 438, 440. When installed on the main body 111, the leading and trailing depth control portions 438, 440 can be circumferentially spaced from one another to create the pocket 442; therefore, in such an example, the radial height RH4 of the pocket portion 442 would be equal to 0. In some examples, the depth control device 430 can have a leading ramped surface 443 between the leading depth control portion 438 and the pocket 442. In some examples the pocket portion 442 corresponds with the at least one of the pocket portions 422a, 422b shown in FIGS. 37-42.

The reducing element gap 444 is a gap defined by the depth control device 430 so as to accommodate the reducing element 216 and the reducing element mount 218. In some examples, the trailing depth control portion 440 can be positioned in contact with the trailing face 237 of the reducing element mount 218. In some examples, the leading depth control portion 438, specifically the depth extension 446, can be circumferentially spaced in the direction of rotation R from the leading face 224 of the reducing element 216.

In some examples, the radial heights RH2 and RH3 of the depth extensions 446,448 are equal to or greater than 50 percent of the radial height RH1 of the reducing element 216. In some examples, the radial heights RH5 and RH6 of the depth extensions 458, 460 are equal to or greater than 75 percent of the radial height RH1 of the reducing element 216. In some examples, the radial height RH4 of the pocket portion 442 is equal to or less than 25 percent of the radial height RH1 of the reducing component 216. In some examples, the radial height RH4 is equal to or less than 15 percent of the radial height RH1 of the reducing component 216. In some examples, the radial height RH4 is equal to or less than 10 percent of the radial height RH1 of the reducing component 216.

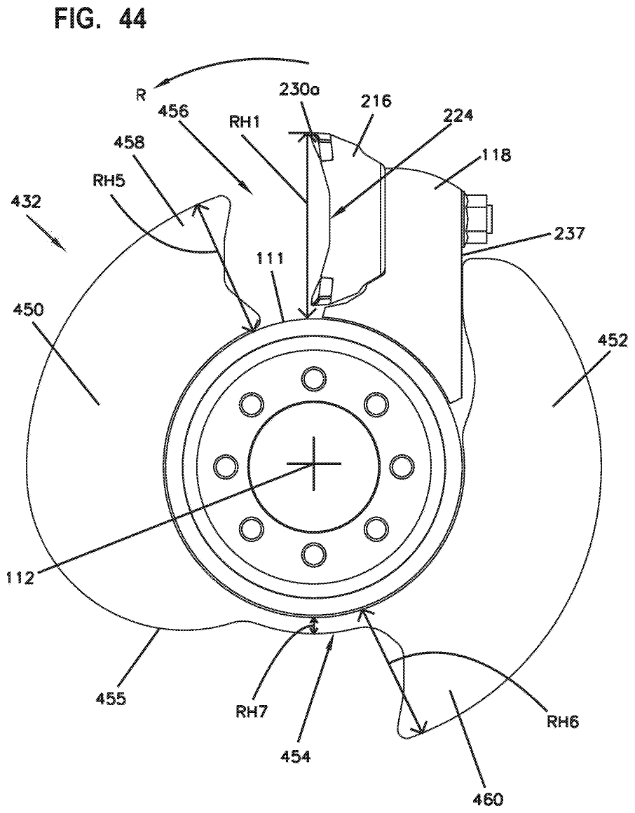

FIG. 44 shown the depth control device 432 positioned circumferentially adjacent an example reducing element 216. Reducing elements 116 and 316 can also be used. As described above, the reducing element 216 has the radial height of RH1 from the main body 111. Like the depth control device 430, the depth control device 432 includes a leading depth control portion 450, a trailing depth control portion 452, a pocket portion 454 between the leading and trailing depth control portions 450, 452, and a reducing element gap 456 between the leading and trailing depth control portions 450, 452.

While similar to the depth control device 430, the leading depth control portion 450 extends a greater distance along the circumference of the main body 111 as compared to the leading depth control portion 438 of the depth control device 430. The leading depth control portion 450 is positioned in front of the reducing component 216 in the direction of rotation R. The leading depth control portion 450 includes a depth extension 458 that has a radial height RH5 from the main body 111. In some examples, the leading depth control portion 450 has a consistent radial height. In other examples, the leading depth control portion 450 has a decreasing height in the direction of rotation R. In other examples, the leading depth control portion 450 has an increasing height in the direction of rotation R

The trailing depth control portion 452 is positioned behind the reducing component 216 in a direction opposite the direction of rotation R. The trailing depth control portion 452 includes a depth extension 460 that has a radial height RH6 from the main body 111. In some examples, the trailing depth control portion 452 is substantially similar to the trailing depth control portion 440 of the depth control device 430. In some examples, the trailing depth control portion 452 has a consistent radial height. In other examples, the trailing depth control portion 452 has a decreasing height in the direction of rotation R. In other examples, the trailing depth control portion 452 has an increasing height in the direction of rotation R.

The pocket portion 454 is positioned between the leading depth control portion 450 and the trailing depth control portion 452. In some examples, the pocket portion 454 has a radial height RH7 from the main body 111. In some examples, the depth control device 432 is constructed of only the leading and trailing depth control portions 450, 452. When installed on the main body 111, the leading and trailing depth portions 450, 452 can be circumferentially spaced from one another to create the pocket 454; therefore, in such an example, the radial height RH7 of the pocket portion 442 would be equal to 0. In some examples, the depth control device 432 can have a leading ramped surface 455 between the leading depth control portion 450 and the pocket 454. As noted above, because the leading depth control portion 450 extends a greater distance along the circumference of the main body 111 as compared to the leading depth control portion 438 of the depth control device 430, the pocket 454 extends a lesser distance along the circumference of the main body 111 as compared to the pocket portion 442 of the depth control device 430. In some examples the pocket portion 454 corresponds with the at least one of the pocket portions 422a, 422b shown in FIGS. 37-42.

The reducing element gap 456 is a gap defined by the depth control device 432 so as to accommodate the reducing element 216 and the reducing element mount 218. The reducing element gap 456 is substantially similar to the reducing element gap 444 of the depth control device 430 described above. In some examples, the trailing depth control portion 452 can be positioned in contact with the trailing face 237 of the reducing element mount 218. In some examples, the leading depth control portion 450, specifically the depth extension 458, can be circumferentially spaced in the direction of rotation R from the leading face 224 of the reducing element 216.

In some examples, the radial heights RH5 and RH6 of the depth extensions 458, 460 are equal to or greater than 50 percent of the radial height RH1 of the reducing element 216. In some examples, the radial heights RH5 and RH6 of the depth extensions 458, 460 are equal to or greater than 75 percent of the radial height RH1 of the reducing element 216. In some examples, the radial height RH7 of the pocket portion 454 is equal to or less than 25 percent of the radial height RH1 of the reducing component 216. In some examples, the radial height RH7 is equal to or less than 15 percent of the radial height RH1 of the reducing component 216. In some examples, the radial height RH7 is equal to or less than 10 percent of the radial height RH1 of the reducing component 216.

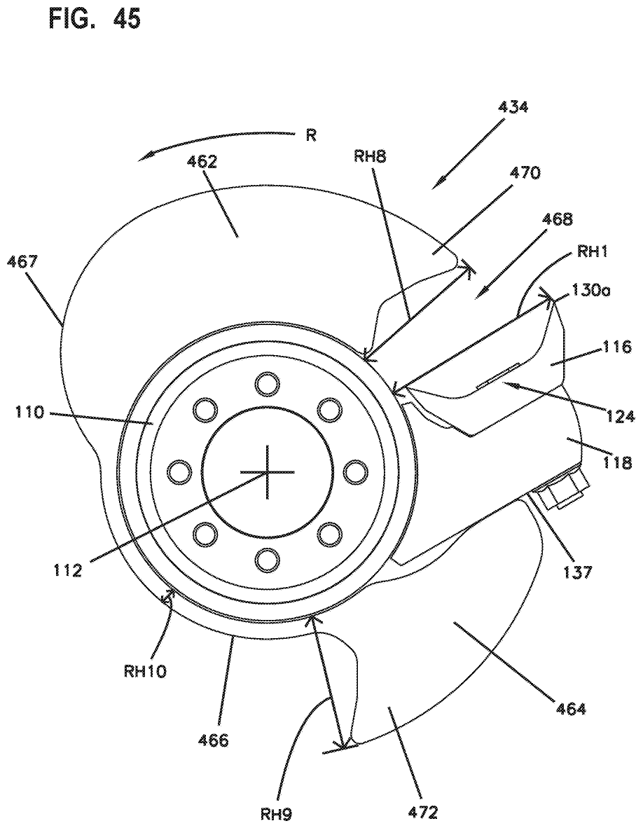

FIG. 45 shows the depth control device 434 positioned circumferentially adjacent an example reducing element 116. Reducing elements 216 and 316 can also be used. As described above, the reducing element 116 has the radial height of RH1 from the main body 111. Like the depth control devices 430, 432, the depth control device 434 includes a leading depth control portion 462, a trailing depth control portion 464, a pocket portion 466 between the leading and trailing depth control portions 462, 464, and a reducing element gap 468 between the leading and trailing depth control portions 462, 464.

While similar to the depth control devices 430, 432, the leading depth control portion 462 extends a greater distance along the circumference of the main body 111 as compared to the leading depth control portion 438 of the depth control device 430 but a lesser circumferential distance than the leading depth control portion 450 of the depth control device 432. The leading depth control portion 462 is positioned in front of the reducing component 116 in the direction of rotation R. The leading depth control portion 462 includes a depth extension 470 that has a radial height RH8 from the main body 111. In some examples, the leading depth control portion 462 has a consistent radial height. In other examples, the leading depth control portion 462 has a decreasing height in the direction of rotation R. In other examples, the leading depth control portion 462 has an increasing height in the direction of rotation R.

The trailing depth control portion 464 is positioned behind the reducing component 116 in a direction opposite the direction of rotation R. The trailing depth control portion 464 includes a depth extension 472 that has a radial height RH9 from the main body 111. In some examples, the trailing depth control portion 452 extends a lesser distance along the circumference of the main body 111 as compared to the trailing depth control portion 440 of the depth control device 430 and the trailing depth control portion 452 of the depth control device 432. In some examples, the trailing depth control portion 464 has a consistent radial height. In other examples, the trailing depth control portion 464 has a decreasing height in the direction of rotation R. In other examples, the trailing depth control portion 464 has an increasing height in the direction of rotation R.

The pocket portion 466 is positioned between the leading depth control portion 462 and the trailing depth control portion 464. In some examples, the pocket portion 466 has a radial height RH10 from the main body 111. In some examples, the depth control device 434 is constructed of only the leading and trailing depth control portions 462, 464. When installed on the main body 111, the leading and trailing depth portions 462, 464, can be circumferentially spaced from one another to create the pocket 466; therefore, in such an example, the radial height RH10 of the pocket portion 466 would be equal to 0. In some examples, the depth control device 434 can have a leading ramped surface 467 between the leading depth control portion 462 and the pocket 466. As noted above, because the leading depth control portion 462 extends a greater distance along the circumference of the main body 111 as compared to the leading depth control portion 438 of the depth control device 430, the pocket 466 extends a lesser distance along the circumference of the main body 111 as compared to the pocket portion 442 of the depth control device 430. In some examples the pocket portion 466 corresponds with the at least one of the pocket portions 422a, 422b shown in FIGS. 37-42.

The reducing element gap 468 is a gap defined by the depth control device 434 so as to accommodate the reducing element 116 and the reducing element mount 118. The reducing element gap 456 is substantially similar to the reducing element gaps 444, 456 of the depth control devices 430, 432 described above. In some examples, the trailing depth control portion 464 can be positioned in contact with the trailing face 137 of the rotary reducing element mount 118. In some examples, the leading depth control portion 462, specifically the depth extension 470, can be circumferentially spaced in the direction of rotation R from the leading face 124 of the reducing element 116.

In some examples, the radial heights RH8 and RH9 of the depth extensions 470, 472 are equal to or greater than 50 percent of the radial height RH1 of the reducing element 116. In some examples, the radial heights RH8 and RH9 of the depth extensions 470, 472 are equal to or greater than 75 percent of the radial height RH1 of the reducing element 116. In some examples, the radial height RH10 of the pocket portion 454 is equal to or less than 25 percent of the radial height RH1 of the reducing component 116. In some examples, the radial height RH10 is equal to or less than 15 percent of the radial height RH1 of the reducing component 116. In some examples, the radial height RH10 is equal to or less than 10 percent of the radial height RH1 of the reducing component 116.

The various embodiments described above are provided by way of illustration only and should not be construed to limit the claims attached hereto. Those skilled in the art will readily recognize various modifications and changes that may be made without following the example embodiments and applications illustrated and described herein, and without departing from the true spirit and scope of the following claims.

We claim:

1. A reducing element comprising:
a main body defining a fastener opening for securing the reducing element to a reducing element mount, the fastener opening defining a fastener axis;
a leading face defined by the main body, the leading face having a first cutting edge, and an opposite second cutting edge, the first and second cutting edges being equally spaced from the fastener opening;
a trailing face defined by the main body, the trailing face being opposite of the leading face, the trailing face including a mounting face that is configured to mount to the reducing element mount; and
a pair of mating features defined by the trailing face, the mating features being equally spaced from the fastener opening, wherein the mating features have a generally arcuate cross-section perpendicular to the fastener axis.

2. The reducing element of claim 1, wherein the mating features are recesses defined in the trailing face.

3. The reducing element of claim 1, wherein the mating features have a concave cross-section perpendicular to the fastener axis.

4. A reducing element system comprising:
a reducing element including:
a main body defining a fastener opening for securing the reducing element to a reducing element mount, the fastener opening defining a fastener axis;
a leading face defined by the main body, the leading face having a first cutting edge, and an opposite second cutting edge, the first and second cutting edges being equally spaced from the fastener opening;
a trailing face defined by the main body, the trailing face being opposite of the leading face, the trailing face including a mounting face that is configured to mount to the reducing element mount; and
a pair of mating features defined by the trailing face, the mating features being equally spaced from the fastener opening, wherein the mating features have a generally arcuate cross-section perpendicular the fastener axis; and
a reducing element mount including:
a main body defining a fastener opening for securing the reducing element to the reducing element mount, the fastener opening defining a fastener axis;
a leading face defined by the main body, the leading face including a reducing element mounting face configured to receive the mounting face of the reducing element; and
a reducing element mount mating feature defined by the leading face, wherein the mating feature has a generally arcuate cross-section perpendicular to the fastener axis;
wherein the reducing element mount mating feature of the reducing element mount is configured to mate with at least one of the mating features of the reducing element when the reducing element mounting face is mated with the mounting face of the reducing element.

5. The reducing element system of claim 4, wherein the mating features of the reducing element are recesses.

6. The reducing element system of claim 4, wherein the mating feature of the reducing element mount is a projection.

7. The reducing element system of claim 4, wherein the mating feature of the reducing element mount is adjacent the reducing element mounting face.

8. The reducing element of claim 4, wherein the mating features of the reducing element have a concave cross-section perpendicular to the fastener axis of the reducing element.

9. The reducing element system of claim 4, further comprising a support surface adjacent the reducing element mount mating feature, the support surface defining a support surface plane that is generally transverse to a plane defined by the reducing element mounting face.

10. A reducing element mount including:
a main body defining a fastener opening for securing the reducing element to the reducing element mount, the fastener opening defining a fastener axis;
a leading face defined by the main body, the leading face including a reducing element mounting face configured to receive the mounting face of the reducing element; and
a reducing element mount mating feature defined by the leading face, wherein the mating feature has a generally arcuate cross-section perpendicular to the fastener axis.

11. The reducing element mount of claim 10, wherein the mating feature of the reducing element mount is adjacent the reducing element mounting face.

12. The reducing element mount of claim 10, further comprising a support surface adjacent the reducing element mount mating feature, the support surface defining a support surface plane that is generally transverse to a plane defined by the reducing element mounting face.
